(19) United States
(12) Patent Application Publication
(10) Pub. No.: US 2019/0369952 A1
(43) Pub. Date: Dec. 5, 2019

(54) VOICE MEMORANDUM APPLICATION USER INTERFACE

(71) Applicant: Apple Inc., Cupertino, CA (US)

(72) Inventors: Alexander Harry Little, Woodside, CA (US); Sascha Höhne, Hamburg (DE)

(21) Appl. No.: 16/421,169

(22) Filed: May 23, 2019

Related U.S. Application Data
(60) Provisional application No. 62/679,931, filed on Jun. 3, 2018.

(51) Int. Cl. G06F 3/16; G06F 3/0481; G06F 3/0485; G06F 3/0482; G11B 27/031

(52) U.S. Cl. CPC G06F 3/165; G06F 3/04817; G06F 2203/04806; G06F 3/0482; G11B 27/031; G06F 3/0485

(57) ABSTRACT

Systems, methods, and non-transitory, tangible, and computer-readable mediums may be used to provide an efficient voice memorandum program interface for a voice memorandum program that is consistent between various modes and operations of the voice memorandum program while clearly illustrating actions to be performed in response to various inputs of the voice memorandum program interface.

### CROSS-REFERENCE TO RELATED APPLICATIONS

This application claims priority to U.S. Provisional Patent Application No. 62/679,931, entitled “Voice Memorandum Application User Interface,” filed Jun. 3, 2018, which this application incorporates in its entirety for all purposes.

### BACKGROUND

The present disclosure relates generally to voice memorandum applications and, more particularly, providing a graphical user interface (GUI) for the voice memorandum applications.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic devices may be utilized as a voice memorandum recorder and playback device using a voice memorandum program. However, navigating menus or operating the various functions of the voice memorandum program user interfaces may make utilizing the voice memorandum difficult or may lead to a user being unclear as to what actions are to occur for the voice memorandum when utilizing the voice memorandum application user interface.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Systems, methods, and non-transitory, tangible, and computer-readable mediums may be used to provide an efficient voice memorandum program interface for a voice memorandum program that is consistent between various modes and operations of the voice memorandum program while clearly illustrating actions to be performed in response to various inputs of the voice memorandum program interface.

In a first embodiment, the voice memorandum application user interface displays an audio recording representation of an audio recording. The voice memorandum application user interface receives a first selection of a first location in the audio recording representation. The first location corresponds to a first time of the audio recording. The voice memorandum application user interface also receives a navigation input to traverse the displayed audio recording representation to a second location in the audio recording representation. The voice memorandum application user interface also receives a second selection of the second location in the displayed audio recording representation. The second location corresponds to a second time of the audio recording. The voice memorandum application user interface also receives an audio input. While receiving the audio input, the voice memorandum application user interface displays a representation of the audio input between the first and second locations of the displayed audio recording representation. The voice memorandum application user interface then replaces a portion of the audio recording corresponding to a portion of the displayed audio recording representation located between the first and second locations. Replacing the portion includes shifting subsequent portions of the audio recording forward or backward in the audio recording based at least in part on a length of the portion and a length of the audio input.

In a second embodiments, an electronic device records one or more voice memorandums. A voice memorandum application interface on the electronic device presents, in the voice memorandum application user interface, a visual indicator for each of the one or more voice memorandums. The voice memorandum application interface is also used to receive a selection of a voice memorandum of the one or more voice memorandums. In response to the selection of the voice memorandum, the voice memorandum application interface presents a voice memorandum graphical user interface that includes a dynamic button that alternates appearance based at least in part on a selected type of function selected from a plurality multiple types of functions to be performed on the voice memorandum. The selected type of function is selected from the multiple types of functions based at least in part on a location of a playhead of the voice memorandum application in an audio recording representation corresponding to audio of the voice memorandum, an active mode activated for the voice memorandum application, or a number of reference points set on the audio recording representation in the voice memorandum application.

In a third embodiment, a voice memorandum application user interface displays a first representation of an audio recording in a voice memorandum application user interface configured to represent the entire audio recording. The first representation comprises a selection window configured to select a portion of the audio recording. The voice memorandum application interface displays a second representation of the audio recording configured to represent a zoomed view of a portion of the audio recording. The voice memorandum application interface receives a selection of a trim mode for the voice memorandum application user interface. The voice memorandum application user interface also receives a first selection of a first location in the audio recording representation using the first or second representation of the audio recording, the first location corresponding to a first time of the audio recording. The voice memorandum application user interface receives a second selection of a second location in the displayed audio recording representation, the second location corresponding to a second time of the audio recording. The voice memorandum application user interface removes at least a portion of the audio recording based at least in part on the first and second selection.

### BRIEF DESCRIPTION OF THE DRAWINGS

Various aspects of this disclosure may be better understood upon reading the following detailed description and upon reference to the drawings in which:

FIG. 1 is a block diagram of an electronic device used to record and/or edit voice memorandums, in accordance with an embodiment of the present disclosure;

FIG. 2 is one example of the electronic device of FIG. 1, in accordance with an embodiment of the present disclosure;

FIG. 3 is another example of the electronic device of FIG. 1, in accordance with an embodiment of the present disclosure;

FIG. 4 is another example of the electronic device of FIG. 1, in accordance with an embodiment of the present disclosure;

FIG. 5 is another example of the electronic device of FIG. 1, in accordance with an embodiment of the present disclosure;

FIG. 6 illustrates library screen of a voice memorandum program interface having a list of available voice memorandums and a minimized card, in accordance with an embodiment of the present disclosure;

FIG. 7 illustrates a simple record screen with an expanded card in the voice memorandum program interface initiated by selection of a record in the library screen of FIG. 6, in accordance with an embodiment of the present disclosure;

FIG. 8 illustrates a library screen in the voice memorandum program interface that is displayed when recording is paused in the simple record screen of FIG. 7, in accordance with an embodiment of the present disclosure;

FIG. 9 illustrates a more screen in the voice memorandum program interface that is displayed when a more button is selected in the library screen of FIG. 6 or FIG. 8, in accordance with an embodiment of the present disclosure;

FIG. 10 illustrates a detailed view screen that is displayed when the expanded card of FIG. 7 is selected, in accordance with an embodiment of the present disclosure;

FIG. 11 illustrates a pause screen of the voice memorandum program interface that is displayed when recording is stopped in the detailed view screen of FIG. 10, in accordance with an embodiment of the present disclosure;

FIG. 12 illustrates a pause screen of the voice memorandum program interface that is displayed when the pause screen of FIG. 11 is minimized, in accordance with an embodiment of the present disclosure;

FIG. 13 illustrates a resumed recording screen of the voice memorandum program interface that is displayed when recording is resumed in the pause screen of FIG. 11, in accordance with an embodiment of the present disclosure;

FIG. 14 illustrates a simple resume recording screen of the voice memorandum program interface that is displayed when the resumed recording screen of FIG. 13 is minimized, in accordance with an embodiment of the present disclosure; and

FIG. 15 illustrates a replace screen of the voice memorandum program interface that is displayed when a playhead of the detailed view screen of FIG. 10 moves from an end of a representation of the audio recording to a beginning of the representation, in accordance with an embodiment of the present disclosure;

FIG. 16 illustrates a simple replace screen of the voice memorandum program interface that is displayed when the replace screen of FIG. 15 is minimized, in accordance with an embodiment;

FIG. 17 illustrates a replacement recording screen of the voice memorandum program interface that is displayed when the recording is started in the replace screen of FIG. 15, in accordance with an embodiment;

FIG. 18 illustrates a replace screen of the voice memorandum program interface that is displayed when a playhead of the detailed view screen of FIG. 10 moves from an end of a representation of the audio recording to a middle of the representation, in accordance with an embodiment;

FIG. 19 illustrates a simple replace screen of the voice memorandum program interface this is displayed when the replace screen of FIG. 18 is minimized, in accordance with an embodiment;

FIG. 20 illustrates a replacement recording screen of the voice memorandum program interface that is displayed when the recording is started in the replace screen of FIG. 18, in accordance with an embodiment;

FIG. 21 illustrates a replacement recording trim screen of the voice memorandum program interface that is displayed when a trim option is selected in the voice memorandum program interface, in accordance with an embodiment;

FIG. 22 illustrates a trim screen of the voice memorandum program interface that is displayed when a selection window handle of the trim screen of FIG. 22 is moved, in accordance with an embodiment;

FIG. 23 illustrates a trim screen of the voice memorandum program interface that is displayed when a portion of the audio recording has been removed, in accordance with an embodiment;

FIG. 24 illustrates a screen of the voice memorandum program interface that is displayed when an end point of a selection is currently being selected, in accordance with an embodiment;

FIG. 25 illustrates an insert screen of the voice memorandum program interface that is displayed when an insert option is selected in the voice memorandum program interface with a playhead at a beginning of the audio recording, in accordance with an embodiment;

FIG. 26 illustrates an insert screen of the voice memorandum program interface that is displayed when an insert option is selected in the voice memorandum program interface with a playhead located in a middle of the audio recording, in accordance with an embodiment;

FIG. 27 illustrates an insert record screen of the voice memorandum program interface that is displayed when an insert option is selected in the insert screen of FIG. 25, in accordance with an embodiment;

FIG. 28 illustrates an record complete screen of the voice memorandum program interface that is displayed recording is completed in the insert record screen of FIG. 27, in accordance with an embodiment;

FIG. 29 illustrates an insert screen of the voice memorandum program interface that is displayed a reference point is set for insertion, in accordance with an embodiment;

FIG. 30 illustrates an insert screen of the voice memorandum program interface that is displayed when a representation of the audio recording is traversed in FIG. 29, in accordance with an embodiment;

FIG. 31 illustrates an insert screen of the voice memorandum program interface that is displayed when two reference points are set, in accordance with an embodiment;

FIG. 32 illustrates an insert screen of the voice memorandum program interface that is displayed when a representation of the audio recording is traversed in FIG. 31, in accordance with an embodiment;

FIG. 33 illustrates an recording progress screen of the voice memorandum program interface that is displayed when a recording is replacing audio corresponding to the representation between the two reference points, in accordance with an embodiment;

FIG. 34 illustrates a record complete screen of the voice memorandum program interface that is displayed when recording in the recording progress screen of FIG. 33 has been completed, in accordance with an embodiment;

FIG. 35 illustrates a loop screen of the voice memorandum program interface that may be used to loop audio when selected reference points for the insertion process, in accordance with an embodiment;

FIG. 36 illustrates an edit screen of the voice memorandum program interface that is displayed when an edit button in the library screen of FIG. 6 or 8 is selected, in accordance with an embodiment;

FIG. 37 illustrates an edit screen of the voice memorandum program interface where two voice memorandums are selected in the edit screen of FIG. 36, in accordance with an embodiment;

FIG. 38 illustrates a confirmation screen of the voice memorandum program interface that presents a confirmation box to confirm that an indicated deletion of the selected memorandums of FIG. 37 is to occur, in accordance with an embodiment;

FIG. 39 illustrates a table/desktop view of the library view of FIG. 6, in accordance with an embodiment;

FIG. 40 illustrates a table/desktop view of a detailed view, in accordance with an embodiment;

FIG. 41 illustrates a process that may be used to perform a replace of audio using the voice memorandum program interface, in accordance with an embodiment;

FIG. 42 illustrates a process of utilizing a dynamic button using the voice memorandum program interface, in accordance with an embodiment; and

FIG. 43 illustrates a process that may be used to perform a trim of audio using the voice memorandum program interface, in accordance with an embodiment.

### DETAILED DESCRIPTION

One or more specific embodiments of the present disclosure will be described below.

These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features.

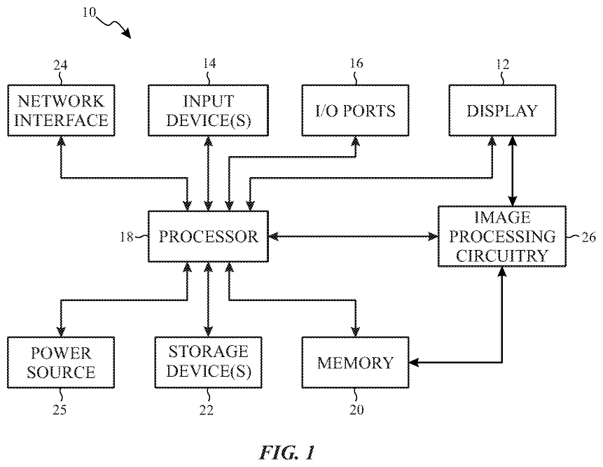

As will be described in more detail below, the electronic device 10 may be any suitable electronic device, such as a computer, a mobile phone, a portable media device, a wearable device, a tablet, a television, a virtual-reality headset, a vehicle dashboard, and the like. Thus, it should be noted that FIG. 1 is merely an example of a particular implementation and is intended to illustrate the types of components that may be present in the electronic device 10.

In the depicted embodiment, the electronic device 10 includes the electronic display 12, one or more input devices 14, one or more input/output (I/O) ports 16, a processor core complex 18 having one or more processor(s) or processor cores, local memory 20, a main memory storage device 22, a network interface 24, a power source 25, and image processing circuitry 26. The various components described in FIG. 1 may include hardware elements (e.g., circuitry), software elements (e.g., a tangible, non-transitory computer-readable medium storing instructions), or a combination of both hardware and software elements. It should be noted that, in some embodiments, the various depicted components may be combined into fewer components or separated into additional components. For example, the local memory 20 and the main memory storage device 22 may be included in a single component. Additionally, the image processing circuitry 26 (e.g., a graphics processing unit (GPU)) may be at least partially included in the processor core complex 18 and/or the display.

As depicted, the processor core complex 18 is operably coupled to the local memory 20 and the main memory storage device 22. Thus, the processor core complex 18 may execute instruction stored in local memory 20 and/or the main memory storage device 22 to perform operations, such as generating and/or transmitting image data. As such, the processor core complex 18 may include one or more general purpose microprocessors, one or more application specific processors (ASICs), one or more field programmable logic arrays (FPGAs), or any combination thereof. Furthermore, as previously noted, the processor core complex 18 may include one or more separate processing logical cores that each process data according to executable instructions.

In addition to the executable instructions, the local memory 20 and/or the main memory storage device 22 may store the data to be processed by the cores of the processor core complex 18. Thus, in some embodiments, the local memory 20 and/or the main memory storage device 22 may include one or more tangible, non-transitory, computer-readable media. For example, the local memory 20 may include random access memory (RAM) and the main memory storage device 22 may include read only memory (ROM), rewritable non-volatile memory such as flash memory, hard drives, optical discs, and the like.

As depicted, the processor core complex 18 is also operably coupled to the network interface 24. In some embodiments, the network interface 24 may facilitate communicating data with other electronic devices via network connections. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, and/or a wide area network (WAN), such as a 4G or LTE cellular network.

Additionally, as depicted, the processor core complex 18 is operably coupled to the power source 25. In some embodiments, the power source 25 may provide electrical power to one or more component in the electronic device 10, such as the processor core complex 18 and/or the electronic display 12. Thus, the power source 25 may include any suitable source of energy, such as a rechargeable lithium polymer (Li-poly) battery and/or an alternating current (AC) power converter.

Furthermore, as depicted, the processor core complex 18 is operably coupled to the I/O ports 16. In some embodiments, the I/O ports 16 may enable the electronic device 10 to receive input data and/or output data using port connections. For example, a portable storage device may be connected to an I/O port 16 (e.g., universal serial bus (USB)), thereby enabling the processor core complex 18 to communicate data with the portable storage device. In some embodiments, the I/O ports 16 may include one or more speakers that output audio from the electronic device 10.

As depicted, the electronic device 10 is also operably coupled to input devices 14. In some embodiments, the input device 14 may facilitate user interaction with the electronic device 10 by receiving user inputs. For example, the input devices 14 may include one or more buttons, keyboards, mice, trackpads, and/or the like. The input devices 14 may also include one or more microphones that may be used to capture audio. For instance, the captured audio may be used to create voice memorandums. In some embodiments, voice memorandums may include a single-track audio recording.

Additionally, in some embodiments, the input devices 14 may include touch-sensing components in the electronic display 12. In such embodiments, the touch sensing components may receive user inputs by detecting occurrence and/or position of an object touching the surface of the electronic display 12.

In addition to enabling user inputs, the electronic display 12 may include a display panel with one or more display pixels. The electronic display 12 may control light emission from the display pixels to present visual representations of information, such as a graphical user interface (GUI) of an operating system, an application interface, a still image, or video content, by display image frames based at least in part on corresponding image data. For example, the electronic display 12 may be used to display a voice memorandum application interface for a voice memorandum application that may be executed on the electronic device 10. In some embodiments, the electronic display 12 may be a display using liquid crystal display (LCD), a self-emissive display, such as an organic light-emitting diode (OLED) display, or the like.

As depicted, the electronic display 12 is operably coupled to the processor core complex 18 and the image processing circuitry 26. In this manner, the electronic display 12 may display image frames based at least in part on image data generated by the processor core complex 18 and/or the image processing circuitry 26. Additionally or alternatively, the electronic display 12 may display image frames based at least in part on image data received via the network interface 24 and/or the I/O ports 16.

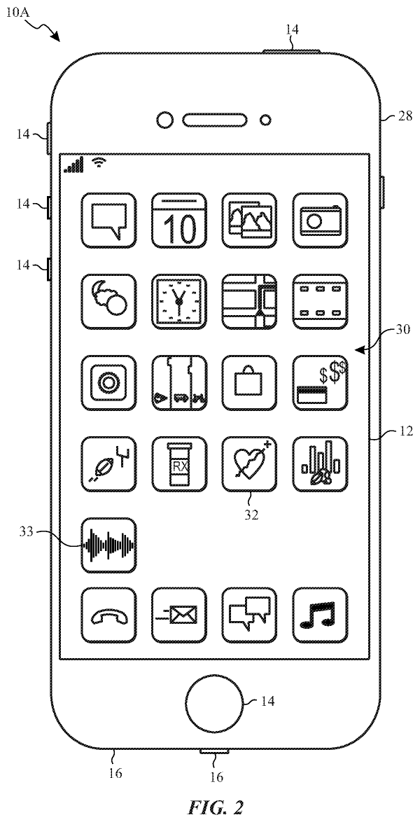

As described above, the electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any IPHONE® model available from Apple Inc.

As depicted, the handheld device 10A includes an enclosure 28 (e.g., housing). The enclosure 28 may protect interior components from physical damage and/or shield them from electromagnetic interference. Additionally, as depicted, the enclosure 28 surrounds at least a portion of the electronic display 12. In the depicted embodiment, the electronic display 12 is displaying a graphical user interface (GUI) 30 having an array of icons 32 including a voice memorandum application icon 33. By way of example, when an icon 32, such as a voice memorandum application icon 33, is selected either by an input device 14 or a touch-sensing component of the electronic display 12, a corresponding application may launch.

Furthermore, as depicted, input devices 14 may extend through the enclosure 28. As previously described, the input devices 14 may enable a user to interact with the handheld device 10A. For example, the input devices 14 may enable the user to record audio, to activate or deactivate the handheld device 10A, to navigate a user interface to a home screen, to navigate a user interface to a user-configurable application screen, to activate a voice-recognition feature, to provide volume control, and/or to toggle between vibrate and ring modes. As depicted, the I/O ports 16 also extends through the enclosure 28. In some embodiments, the I/O ports 16 may include an audio jack to connect to external devices. As previously noted, the I/O ports 16 may include one or more speakers that output sounds from the handheld device 10A.

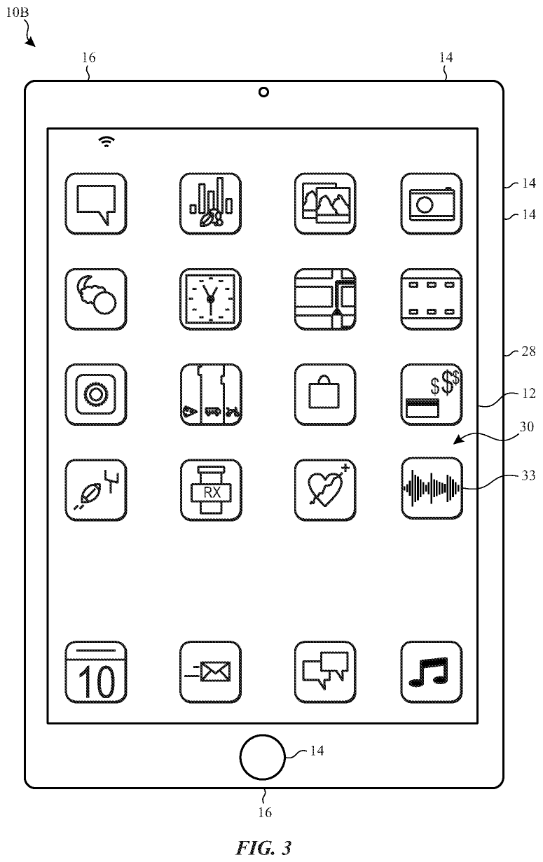

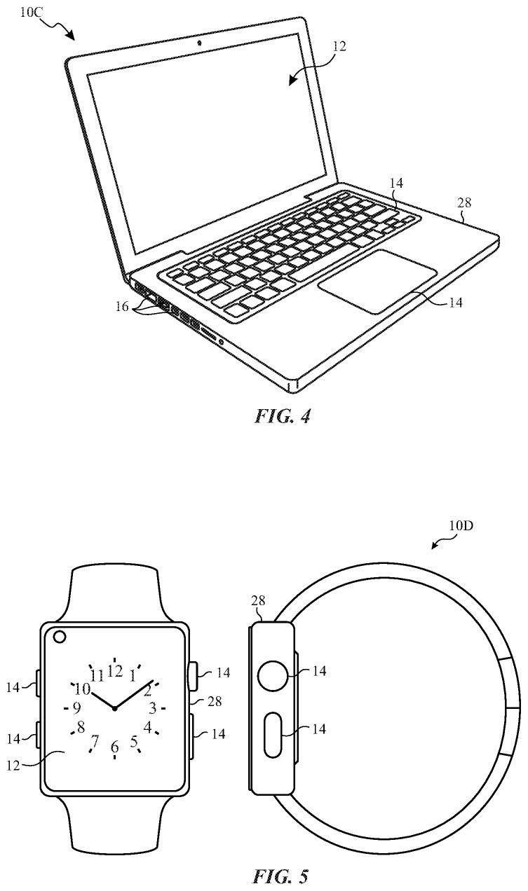

To further illustrate an example of a suitable electronic device 10, specifically a tablet device 10B, is shown in FIG. 3. For illustrative purposes, the tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a wearable device 10D, is shown in FIG. 5. For illustrative purposes, the wearable device 10D may be any APPLE WATCH® model available from Apple Inc. As depicted, the tablet device 10B, the computer 10C, and the wearable device 10D each also includes an electronic display 12, input devices 14, and an enclosure 28.

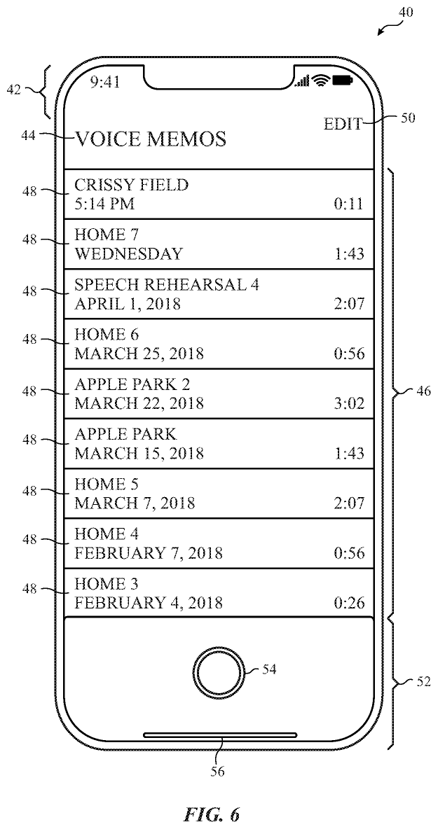

With the foregoing in mind, FIG. 6 is a library screen 40 of a graphical user interface (GUI) of a voice memorandum application. For example, the library screen 40 may be displayed when the voice memorandum application icon 33 is selected using an input device 14 of the electronic device 10. The library screen 40 includes a header 42 that includes various information about the electronic device 10. For example, the header 42 may display a time set for the electronic device, wired or wireless connection statuses of the electronic device 10 to various network types, a charge of a power source of the electronic device, and/or a type of power source for the electronic device. The library screen 40 also includes a title 44 that indicates what is being viewed. For instance, the title 44 shows that the library screen 40 is a library of voice memorandums. The library screen 40 also includes a library list 46 showing visual indications 48 of recorded voice memorandums in a voice memorandum library of the electronic device 10. Each visual indication 48 may include information about the respective voice memorandum. For example, the visual indication 48 may include a title for the voice memorandum, a time and/or date of recording for the voice memorandum, a duration of the voice memorandum, a location where the voice memorandum was recorded, and/or other pertinent information about the voice memorandum. Within the library screen 40, an edit button 50 may be selected to perform actions on the voice memorandums and/or their respective indications 48. For example, the edit button 50 may be used to select which voice memorandums are included in and/or deleted from the library.

The library screen 40 may also include a minimized card 52 that includes a record button 54 that enables creation of a new voice memorandum via a microphone or sound sensor of the electronic device 10. The library screen 40 may also include a home button 56 that closes the voice memorandum application and returns to a home screen of the electronic device 10.

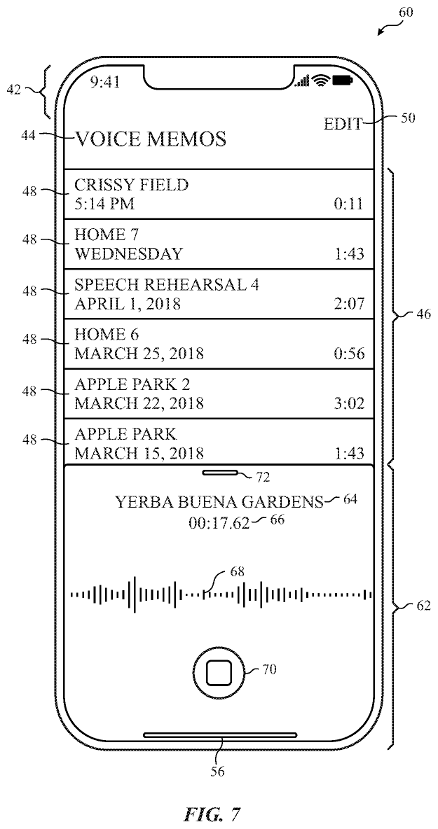

When the record button 54 is selected in the minimized card 52, the electronic device 10 starts a recording and may display a simple record screen 60 having an expanded card 62, as illustrated in FIG. 7. Moreover, the electronic device 10 may use a transition to shift from the minimized card 52 to the expanded card 52. For example, the electronic device 10 may animate an appearance that the minimized card 52 is being slid up from the bottom of the library screen 40 to the position of the expanded card 62 in the simple record screen 60. In the simple record screen 60, a portion of the library list 46 remains visible and may be darkened and/or disabled until the expanded card 62 is minimized. In some embodiments, the library list 46 may fade and/or disappear completely in the simple record screen 60.

The expanded card 62 includes a title 64 for the recording, a time indicator 66 that indicates a duration between a current location and the beginning of the recording, and a representation 68 (e.g., waveform) of the audio recording indicating levels in the audio recording. In some embodiments, the representation 68 begins at a first end (e.g., left side) of the expanded card 62 and traverses the card until the representation 68 reaches a second end (e.g., right side) of the expanded card 62. At this point, the representation 68 may begin scrolling from the second end to the first end.

Since a recording is ongoing while the simple record screen 60 is displayed, the record button 54 may be replaced with a stop button 70 that may be used to stop the current recording. The expanded card 62 also includes a swipe indicator 72 that indicates that the expanded card 62 may be swiped up to show a detailed screen that shows details of and/or provides additional options to be performed on the voice memorandum. In some embodiments, a selection of any portion of the expanded card 62 other than the title 64 or the stop button 70 may display the detailed screen. A selection of the title 64 may provide an edit indication and/or an onscreen keyboard to enable the title 64 to be edited.

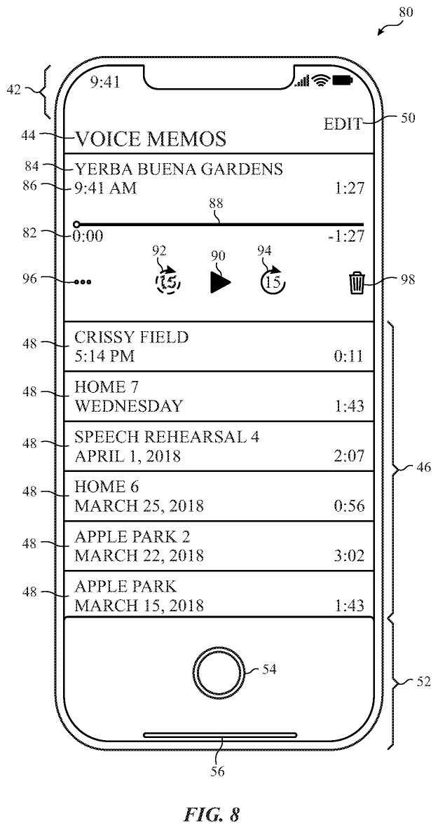

When the electronic device 10 receives a selection of the stop button 70, the electronic device 10 (e.g., the processor core complex 18) stops the recording and display a library screen 80, as illustrated in FIG. 8. The library screen 80 is similar to the library screen 40 of FIG. 6 except that the library screen 80 includes a selected recording box 82 that indicates information about a selected voice memorandum and/or actions that may be performed on the selected voice memorandum. In some embodiments, when the stop button 70 is pressed, the most recent recording is automatically selected in the library screen 80. The selected recording box 82 may include a title 84 of the voice memorandum, a time/date indicator 86 that indicates a date and/or time of the recording of the voice memorandum, and a timeline 88 that indicates a current location in the voice memorandum in relation to end points of the voice memorandum. In some embodiments, the title 84 may be generated using a geographic location of the electronic device 10 during recording and/or generated using a custom name received via the input device 14. The timeline 88 may also be used to navigate within the voice memorandum. The selected recording box 82 may also include a play button 90 that may be used to play the voice memorandum on speaker(s) (e.g., wired/wireless headphones, wired/wireless speakers externally connected to the electronic device 10, etc.) of the electronic device 10.

The selected recording box 82 may include navigation buttons 92 and 94. For example, the navigation buttons 92 and 94 may be used to skip a pre-determined amount of time in a corresponding direction within the voice memorandum. For instance, in some embodiments, the navigation button 92 skips backward by a set amount (e.g., 15 seconds), and the navigation button 94 skips forward by a set amount (e.g., 15 seconds). In some embodiments, the navigations buttons 92 and 94 may skip by different amounts in opposite directions. The selected recording box 82 includes a more button 96 that provides additional options for the selected voice memorandum. Furthermore, the selected recording box 82 includes a delete button 98 that may be used to delete the voice memorandum. In some embodiments, as discussed below, the delete button 98 may move the selected voice memorandum to a recently deleted list for a period of time. Also, in some embodiments, when the selected voice memorandum is deleted, the rest of the library list 46 may move up to fill the space using an animation (e.g., slide-in animation). For example, once the selected voice memorandum is deleted, the electronic device 10 may display the library screen 40 of FIG. 6.

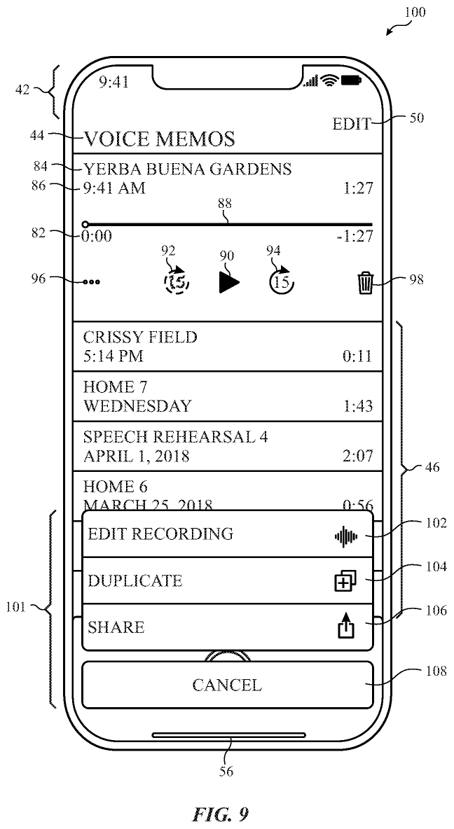

FIG. 9 illustrates a more screen 100 that the electronic device 10 displays in response to receiving a selection of the more button 96. The more screen 100 may be similar to the library screen 80 that is overlaid with a more menu 101 that includes an edit recording button 102, a duplicate button 104, a share button 106, and a cancel button 108. The edit recording button 102 may open the selected recording in a detailed view with a playhead at the current location indicated in the selected recording box 82. Moreover, in some embodiments, if the voice memorandum was in the process of being played when the edit recording button 102 is selected, the playback of the voice memorandum continues while the electronic device 10 displays the detailed view of the voice memorandum. A selection of the duplicate button 104, a copy of the selected voice memorandum is copied and appended with an index number that is incremented for each duplicate of the voice memorandum. The share button 106 opens a share menu that provides options on methods (e.g., email, text, etc.) to share the selected voice memorandum. The cancel button 108 closes the more menu 101 and returns to the library screen 80. Furthermore, in some embodiments, while the electronic device 10 is displaying the more screen 100, the electronic device 10 may disable interaction with the library list 46.

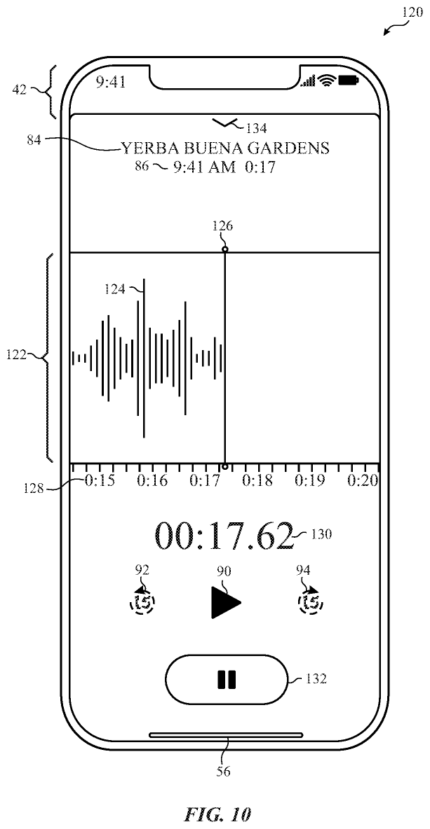

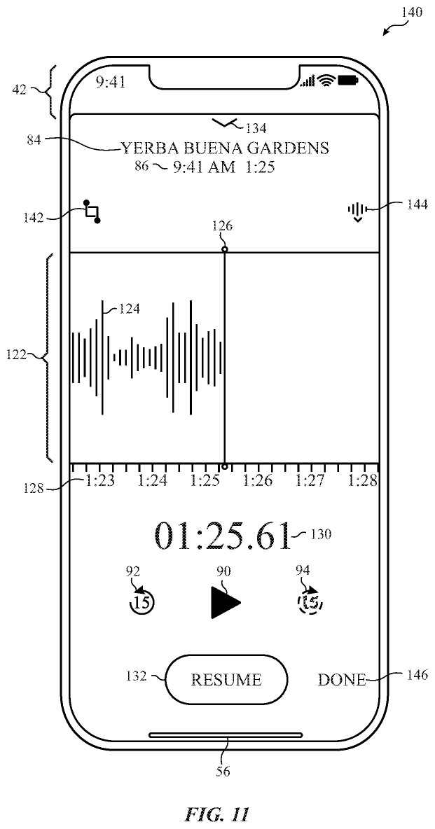

FIG. 10 illustrates a detailed view screen 120 that the electronic device 10 may display in response to a selection of any portion of the expanded card 62 other than the title 64 or the stop button 70 during a recording. The electronic device 10 may transition from the expanded card 62 to the detailed view screen 120 using a sliding animation that makes the expanded card 62 from the appearance of the expanded card 62 to the detailed view screen 120.

The detailed view screen 120 displays the title 84, the play button 90, and the navigation buttons 92 and 94. However, since the voice memorandum is currently being recorded, playback options (e.g., play button 90 and navigation buttons 92 and 94) are disabled. In some embodiments, the playback options may be hidden or dimmed to indicate that the playback options are disabled. The detailed view screen 120 also includes a representation window 122 where a representation 124 (e.g., waveform) representing the voice memorandum shows audio levels in the voice memorandum. The detailed view screen 120 also includes a playhead 126 (or record head) that indicates where the current location within the voice memorandum is illustrated in the representation 124. The representation 125 may include a time scale 128 to portray and provide scale for locations in the representation 124. The representation 124 and/or the playhead 126 may change appearance based on whether the voice memorandum is currently being recorded. For instance, the representation 124/playhead 126 may be a first color (e.g., red) when the voice memorandum is currently being recorded and may be a second color (e.g., white) when the voice memorandum is currently paused in recording. The detailed view screen 120 includes a time indicator 130 indicating a current location in the voice memorandum corresponding to the playhead 126. The detailed view screen 120 also includes a dynamic button 132 that displays various options according to a context, such as whether the voice memorandum is currently being recorded, the location in the voice memorandum, and/or whether the voice memorandum is in a specific mode (e.g., trim mode or replace mode). In the detailed view screen 120, the dynamic button 132 is shown having a pause icon that indicates that the dynamic button 132 may be used to pause the recording. The detailed view screen 120 includes a close button 134 that may be tapped or swiped to minimize the detailed view screen 120 and to return to the expanded card 62 in the simple record screen 60.

Once the dynamic button 132 (and while the playhead 126 is located at an end of the voice memorandum) is pressed to pause the recording, the electronic device 10 shows a resume screen 140, as illustrated in FIG. 11. The resume screen 140 may also be presented in response to a selection of the edit recording button 102 of FIG. 9. The resume screen 140 is similar to the detailed view screen 120 except the representation 124 may have a color (e.g., white) and the playhead 126 may be a different color (e.g., blue) indicative of a pause state. Additionally, since recording is paused, the playback options are re-enabled in the resume screen 140. Furthermore, in the resume screen 140, the electronic device 10 presents the dynamic button 132 with resume text that indicates that the dynamic button 132 may be used to resume the recording of the voice memorandum.

In the resume screen 140 after pausing the voice memorandum, a length of the recording may be updated/added in the title 84. Since recording is paused, the representation 124 may be traversed by moving the playhead 126 using input device(s) 14, such as a swipe, a key press, a mouse movement, and/or other suitable inputs. In some embodiments, a speed of traversal may be set according to a speed or amplitude of swipe or mouse movement. Additionally or alternatively, the traversal may be skip between words of the audio recording. For instance, the processor core complex 18 may analyze the audio to find intervals between words that have a threshold duration while audio amplitude is below a threshold indicating a length of silence suitable to correspond to a space between words. Additionally or alternatively, the processor core complex 18 may analyze the audio to determine portions that sound like a beginning of a word, such as hard consonant sounds.

When the playhead 126 is at the end of the voice memorandum recording, the dynamic button 132 displays a resume option. As discussed below, when the playhead 126 is located at any other location, the dynamic button 132 may display a replace option that enables recording over previously recorded portions of the recorded voice memorandum.

The resume screen 140 also includes a trim option 142 and an insert option 144. As discussed below, the trim option 142 may be used to invoke a trim mode for the voice memorandum application, and the insert option 144 may be used to invoke an insert mode for the voice memorandum application. The resume screen 140 also includes a done button 146 that may be used to save the recording and to return to the library screen 80 of FIG. 8.

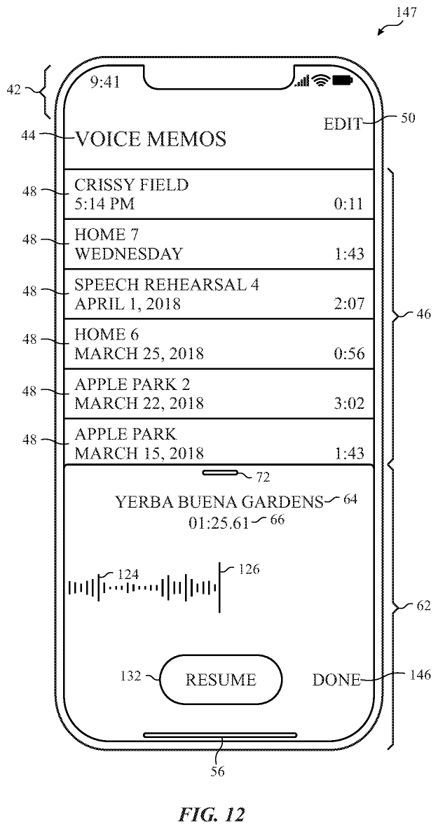

When the close button 134 is closed or swiped, the electronic device 10 may show a simple pause screen 147 having the expanded card 62 illustrated in FIG. 12. The simple pause screen 147 is similar to the simple record screen 60 of FIG. 7. However, the simple pause screen 147 may include different colors of components (e.g., representation 124, playhead 126, etc.) to indicate that the recording has been paused. Furthermore, the simple pause screen 147 may include the dynamic button 132 with resume instructions and the done button 146 that functions just as the done button 146 functions in FIG. 12. If dynamic button 132 is selected, the electronic device 10 will display the simple record screen 60. If any other portion of the expanded card 62 is selected, the electronic device will return to the resume screen 140. In some embodiments, pausing of recordings may be restricted to the detailed view screen 120. In such embodiments, when the dynamic button 132 is selected in the simple pause screen 147, recording continues and the dynamic button 132 is replaced by the stop button 70.

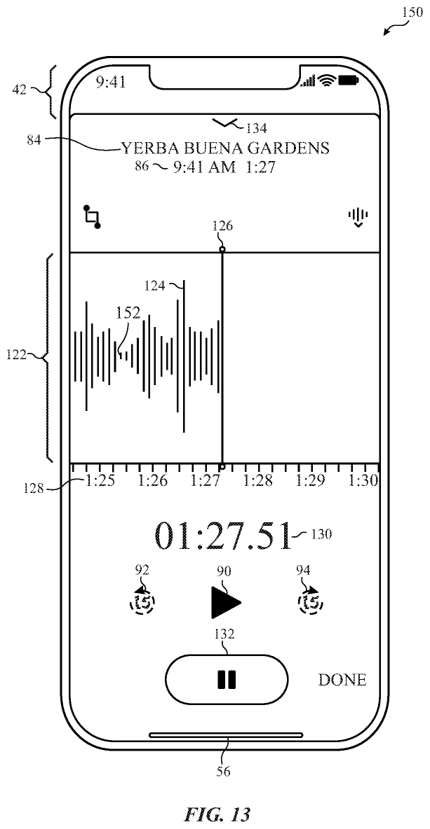

When the dynamic button 132 is selected in the resume screen 140 of FIG. 11, the electronic device 10 displays a resumed recording screen 150 as illustrated in FIG. 13. The resumed recording screen 150 is similar to the detailed view screen 120 of FIG. 10. However, the representation 124 of the resumed recording screen 150 includes a previously recorded portion 152 that indicates corresponds to a previously recorded audio. The previously recorded portion 152 is a first color (e.g., white) to indicate that the recording has already been completed on that portion while the rest of the representation 124 currently being recorded is a different color (e.g., red).

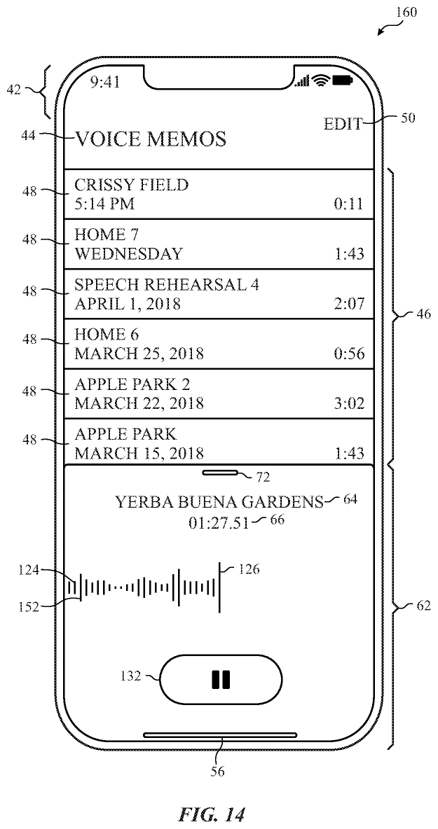

Additionally, if the close button 134 is selected in the resumed recording screen 150, the electronic device 10 displays a simple resumed recording screen 160, as illustrated in FIG. 14. The simple resumed recording screen 160 is similar to the simple record screen of FIG. 7 except that the resumed recording screen 150 includes the previously recorded portion 152.

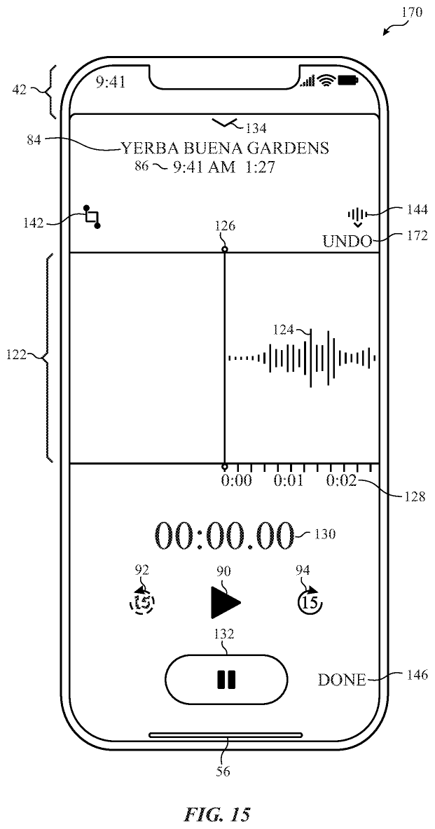

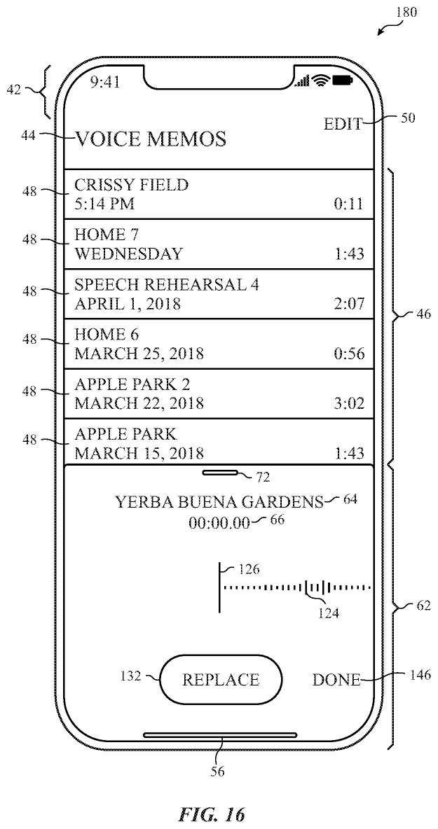

As previously discussed, when inputs cause the playhead 126 to traverse (e.g., move to beginning of) the representation 124 in the resume screen 140, the electronic device causes the dynamic button 132 to include replace text, as illustrated in the replace screen 170 of FIG. 15. When the dynamic button 132 is selected with the replace text, the electronic device 10 will begin replacing audio in the voice memorandum with new recordings starting at a location of the playhead 126 in the voice memorandum. If previous replacements have occurred in the voice memorandum file, the replace screen 170 may include an undo button 172 that may be used to undo previous replacements. In some embodiments, a stack storing the previous undo operations may be cleared once the done button 146 is selected to end an editing session. Other than the dynamic button 132 and the undo button 172, the replace screen 170 functions similar to the resume screen 140 of FIG. 11 except that the replacement using the replace screen 170 overwrites previously recorded audio with newly recorded audio instead of concatenating the newly recorded audio onto the end of the previously recorded audio. Also, selection of the close button 134 in the replace screen 170 will cause the electronic device 10 to display a simple replace screen 180, as illustrated in FIG. 16. The simple replace screen 180 is similar to the simple pause screen 147 except that the dynamic button 132 includes replace text in the simple replace screen 180. Receiving a selection of any portion of the expanded card 62 other than the dynamic button 132 and the done button 146 in the simple replace screen 180 returns to the replace screen 170.

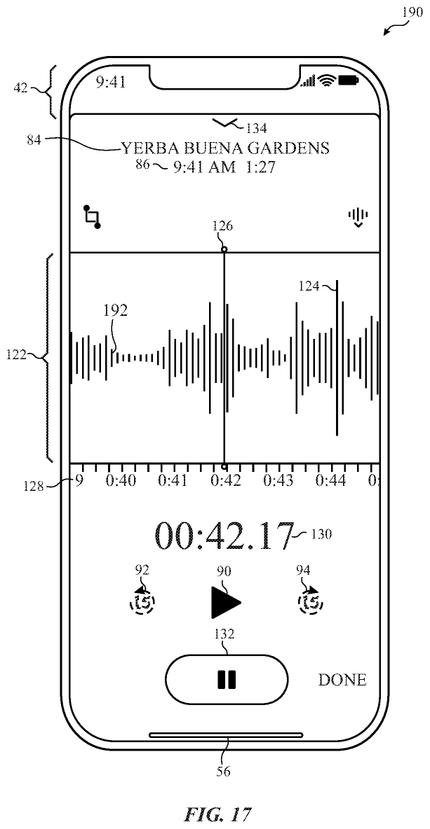

Once a replacement recording has been started using a selection of the dynamic button 132 in the replace screen 170, new recordings are used to overwrite previously recorded audio in the voice memorandum. FIG. 17 illustrates a replacement recording screen 190. The replacement recording screen 190 is similar to the detailed view screen 120 except that the underlying representation 124 already exists with a replacement representation 192 (and its corresponding currently recording audio) overwriting the representation 124 (and its corresponding previously recorded audio) in the replacement recording screen 190. The underlying representation 124 may have a first color (e.g., white) and the replacement representation 192 may have a second color (e.g., red). Since the recording is ongoing, the playhead 126 may have a same color as the replacement representation 192 corresponding to audio currently being recorded.

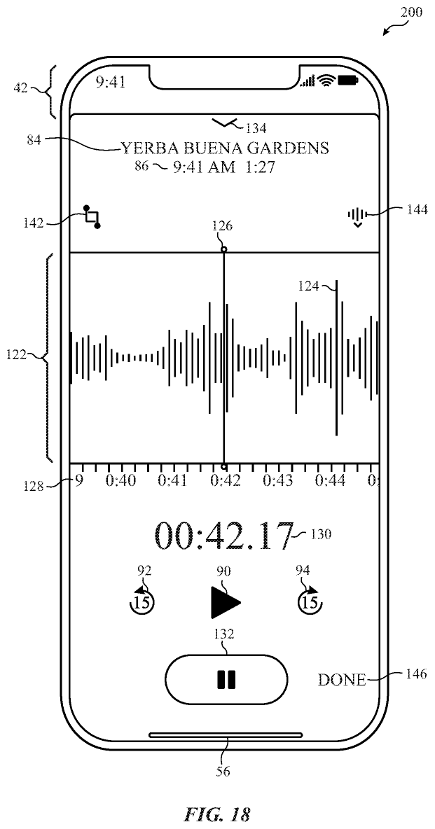

Replacing audio using the voice memorandum application may be performed at more than only the beginning of the representation 124 corresponding to a beginning of the voice memorandum. Indeed, as long as the voice memorandum is not being recorded, the playhead 126 may be moved to any location in the representation 124. When the playhead 126 is located at any location other than the end of the representation 124, the dynamic button 132 enables replacing audio. For instance, the replace screen 200 of FIG. 18 illustrates the playhead 126 located in a middle of the representation 124. Since the playhead 126 is not located at an end of the representation 124, the dynamic button 132 may enable replacement rather resuming the voice memorandum recording. In other words, if audio exists where the playhead 126 is located, the dynamic button 132 enables replacement of the audio with newly recorded audio. Otherwise, the dynamic button 132 enables concatenation of the newly recorded audio.

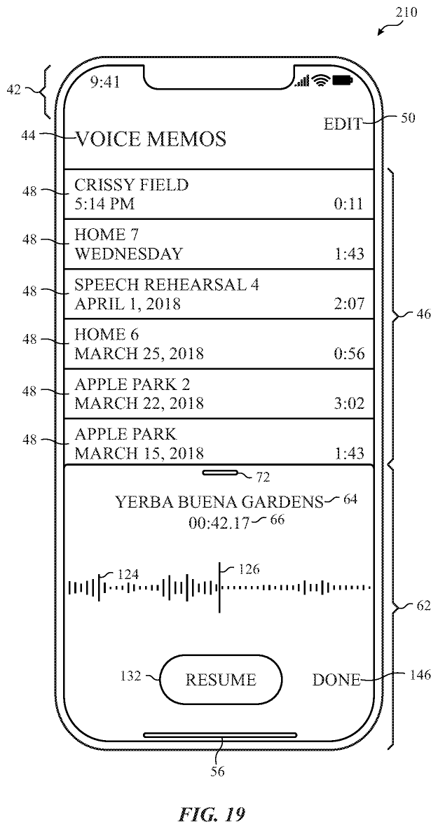

If the close button 134 is selected in the replace screen 200, the electronic device 10 presents a simple replace screen 210 as illustrated in FIG. 19. The simple replace screen 210 is similar to the simple replace screen 180 except that the selection of any portion of the expanded card 62 of the simple replace screen 210 other than the dynamic button 132, the title 84, and the done button 146 causes the electronic device 10 to display the replace screen 200.

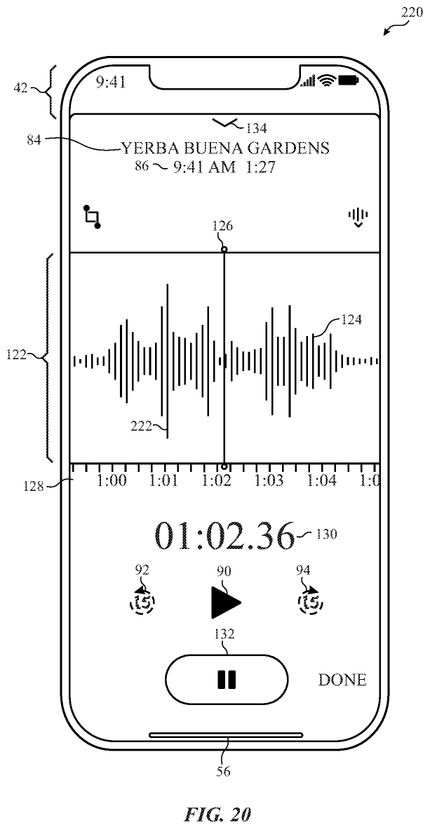

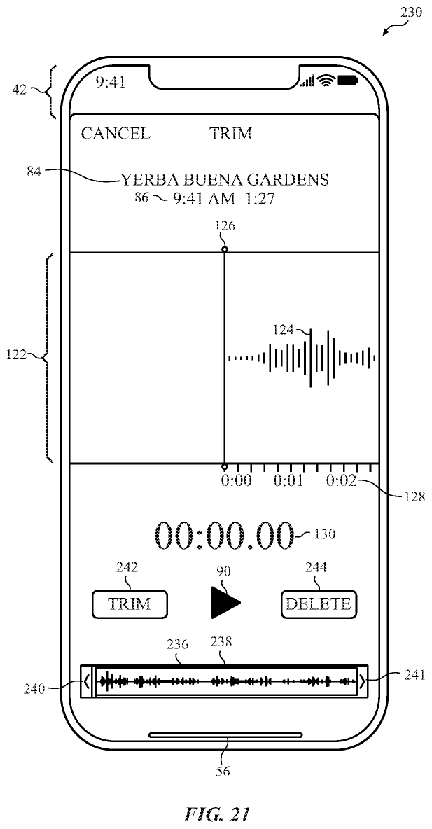

If the dynamic button 132 is pressed in the context of the replace screen 200, the electronic device 10 starts recording and overwriting audio. During recording and rewriting, the electronic device 10 may display a replacement recording screen 220 illustrated in FIG. 20. The replacement recording screen 220 is similar to the replacement recording screen 190 except that a portion of the audio corresponding to the representation 124 occurring before the playhead 126 is preserved when a replacement recording 222 overwrites only portions of the audio corresponding to audio corresponding to portions of the representation 124 occurring after the playhead 126.

### Trim Mode

If the trim option 142 is pressed in the resume screen 140, the replace screen 170, or the replace screen 200, the electronic device 10 initiates a trim mode. During the trim mode, the electronic device 10 may display a trim screen, such as the trim screen 230 illustrated in FIG. 21. The trim screen 230 is similar to the resume screen 140 of FIG. 11. However, in the trim screen 230, a trim indicator 232 may be included to indicate that the trim mode is active, and a trim cancel button 234 may be included to cancel the trim mode, undo any trim actions performed since activation of the trim mode, and return to a previous screen used to initiate the trim mode. Also, the trim screen 230 includes a selection representation 236 (e.g., waveform) that may be used to select portions of audio corresponding to the representation 124 using a selection window 238 that may be manipulated using handles 240 and 241. The selection representation 236 may represent levels for an entirety of the audio of the voice memorandum while the representation 124 shows a larger view of a representation of a portion of the audio of the voice memorandum. When the handles 240 and 241 have not been manipulated, no selection has been made. Accordingly, a trim button 242 and a delete button 244 may be dimmed, omitted, and/or disabled.

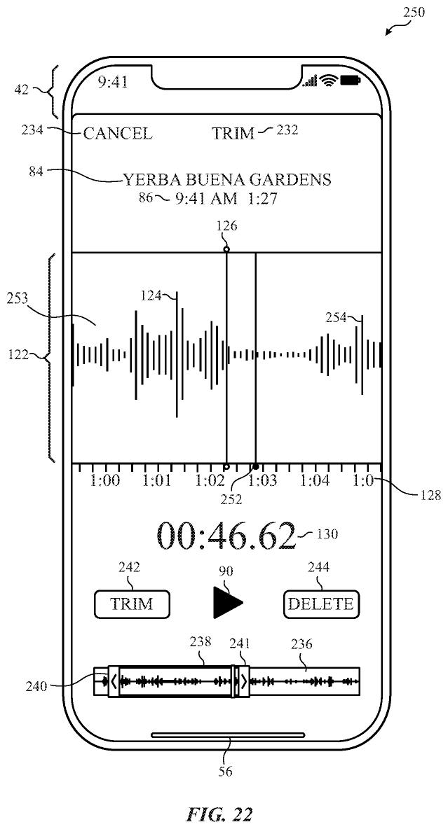

Once a handle 240 or 241 is moved, a color of the selection window 238 may change. For example, the selection window 238 may change from grey indicating no selection to yellow indicating that the selection is active when at least one handle 240 or 241 has been moved. For instance, FIG. 22 illustrates a trim screen 250 where the handle 241 has been moved from an end of the selection representation 236. In addition to or in place of the color change of the selection window 238, the trim button 242 and the delete button 244 may be enabled in response to the selection of a portion of the selection representation 236 using the selection window 238.

When the trim button 242 is active and selected, the electronic device 10 will remove audio in the voice memorandum that does not correspond to the selection representation 236 inside of the selection window 238. In other words, everything but the selected portion of the audio is discarded. The electronic device 10 then animates the selection representation 236 to fill the space across the trim screen 250. After the transition animation, the screen will be set back to “no selection” similar to that shown in the trim screen 230.

When the delete button 244 is active and selected, the electronic device 10 will remove audio in the voice memorandum that corresponds to the selection window 238. In other words, the selected portion of the audio is discarded. The electronic device 10 then animates the selection representation 236 to fill the space across the trim screen 250. After the transition animation, the screen will be set back to “no selection” similar to that shown in the trim screen 230.

The selected portion of the selection representation 236 may cause an indication of selection in the selection representation 236. In such cases, an indicator 252 may be used to indicate an end of a selected region 253 on the representation 124 corresponding to the selection window 238. Portion 254 outside of the selection window 238 may be dimmed while the selected region 253 is tinted to a different color (e.g., yellow). In the illustrated trim screen 250, the indicator 252 visually indicates that it corresponds to the end of the selection window 238 by including a circle at the bottom of the indicator 252. Another indicator (not shown) corresponding to another end of the selection window 238 in the representation window 122 that may become visible when the representation 124 scrolls through the selection window 238 may include a circle at the top of the other indicator.

In some embodiments, the indicator 252 may be selected and moved on the representation 124 to change the corresponding edge of the selection window 238. In other words, in such embodiments, changes to the selection window 238 may be made using the handle 240, handle 241, indicator 252, or the other indicator (not shown). The representation window 122 may temporarily focus on a point set using the selection representation 236 before returning to the playhead 126 location. Furthermore, the time indicator 130 may also temporarily change to the point sent using the selection representation 236.

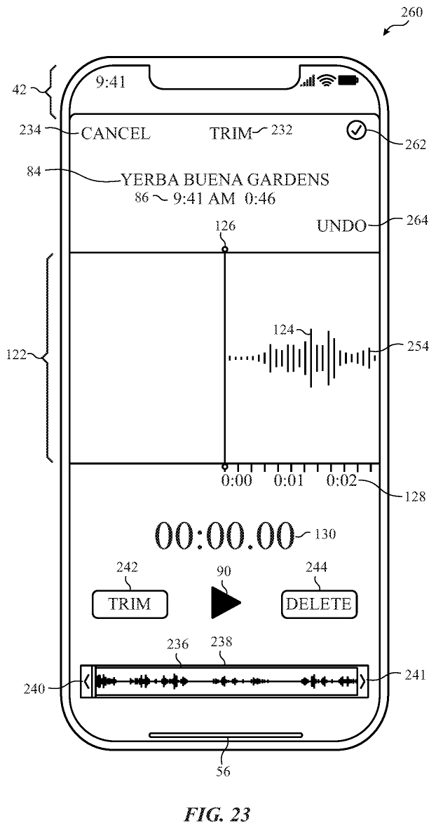

FIG. 23 illustrates a trim screen 260 where the selected region 253 of the audio has been removed via a delete operation leaving only the remaining portion 254. The remaining portion 254 of the selection representation 236 outside of the previously set selection window 238 has been stretched to a width of the trim screen 260. The trim handles 240 and 241 are moved to the ends of the new size of the selection representation 236. Since a selection has not been made since the last change, the trim screen 260 may include the handles 240 and 241 as grey/inactive, and the electronic device 10 disables the trim button 242 and the delete button 244.

The trim screen 260 may also include a confirmation button 262 where the previously performed trim/edit operations may be confirmed, ending the trim mode session, and returning to a screen where the trim mode was invoked using the trim option 142. In response to a selection of the confirmation button 262, the electronic device 10 may ask whether to save the changes in the original recording, save as a new recording, or abort confirmation. If the cancel button 234 is selected instead of the confirmation button 262 after a trim/edit, the electronic device 10 may ask for confirmation whether the changes should be discarded or the cancellation may be aborted.

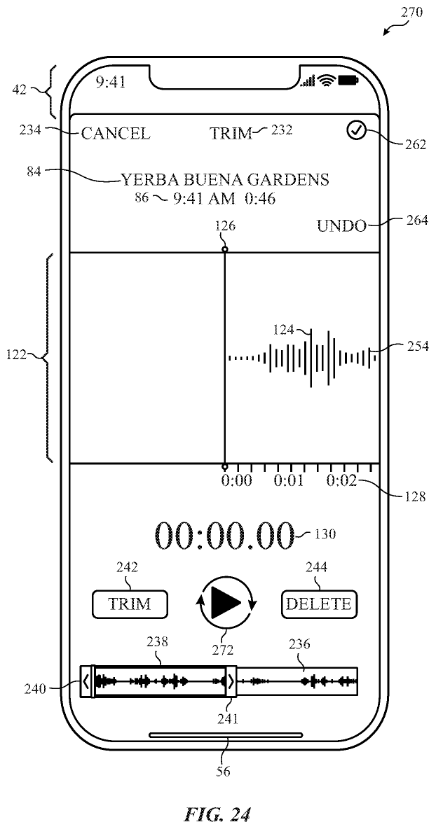

When selecting a point for editing, the voice memorandum application may play short audio clips to verify whether the selected point is the proper location and/or more finely adjust the location of the point. For instance, as illustrated in screen 270 of FIG. 24, when an input is active on any of the end points, the play button 90 will be replaced by a loop icon 272. A selection of the loop icon 272 may result in a continuous loop playback of a region (e.g., 1 second region, one or more words). For instance, when playing back words, the processor core complex 18 may analyze the recorded audio to determine spaces/hard consonants between words and play the interval(s) between the spaces/hard consonants as the looped region. Morevoer, the looped region may be the portion of audio corresponding to an edge of the selection window 238. For instance, if the set point is at a beginning of the selection window 238, the looped region occurs after the point, and if the set point is at an end of the selection window 238, the looped region may occur before the point.

The loop playback will continue until both inputs have been removed. In other words, if the user is holding a trim point, and taps the loop icon 272, the loop behavior will continue until the user removes the touch on the trim point. Similarly, if the user is holding a trim point, holds the loop icon 272, they can remove the touch on the trim point and loop playback will continue. Maintaining looping until both inputs are removed enables multiple fine adjustments while continuing to preview with the loop. Such loop continuance along with updating the loop each time the set point changes provides an accurate preview of the set point.

### Insert Mode

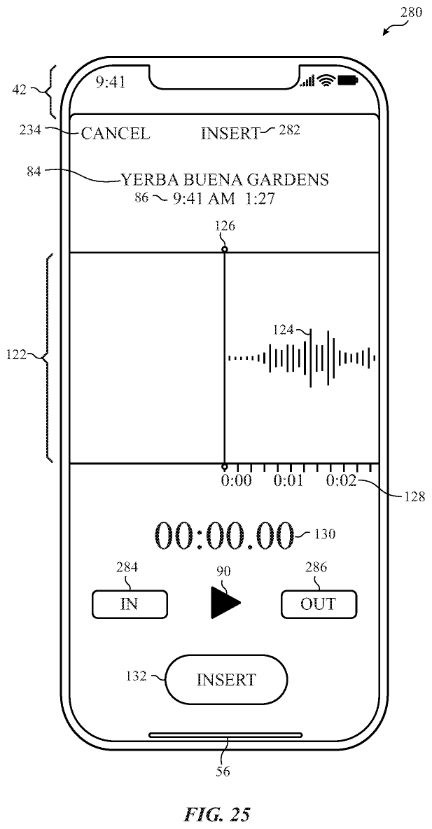

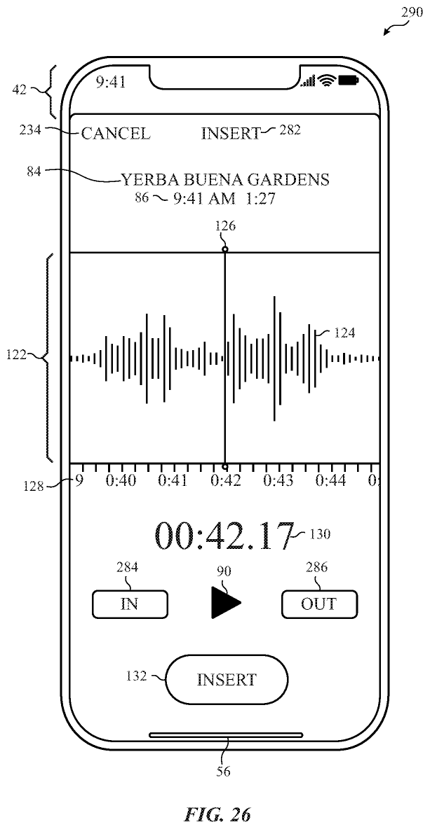

If the insert option 144 is pressed in the resume screen 140, the replace screen 170, or the replace screen 200, the electronic device 10 initiates an insert mode. During the insert mode, the electronic device 10 may display an insert screen, such as the insert screen 280 illustrated in FIG. 25. The insert screen 280 is similar to the resume screen 140 of FIG. 11 except the insert screen 280 includes an insert indicator that indicates that the insert mode is active. The cancel button 234 may be used to cancel the insert mode. Additionally, the insert screen 280 differs from the resume screen 140 by replacing the navigation buttons 92 and 94 with an in button 284 and an out button 286, respectively corresponding to an in point and an out point. Any inserted audio is inserted between the in point and the out point. Any audio corresponding to the representation 124 between the in point and the out point is deleted, and the remaining audio is shifted to accommodate any removed audio and/or inserted audio. When entering the insert mode, the in and out points are not set. Instead, the in and out points may be set using the playhead 126. In some embodiments, the playhead 126 may have a color (e.g., blue) different than the default replacement mode (e.g., red) to easily distinguish the modes. Furthermore, the dynamic button 132 may include text indicating that a selection of the dynamic button 132 will result in an insertion. If no points are set, instead, a selection of the dynamic button 132 results in insertion at a location indicated by the playhead 126 pushing any audio that corresponds to the representation 124 after the location. FIG. 26 shows an insert screen 290 that is similar to the insert screen 280 of FIG. 25 except that the playhead 126 is located in a middle of the representation 124 rather than at a beginning of the representation 124.

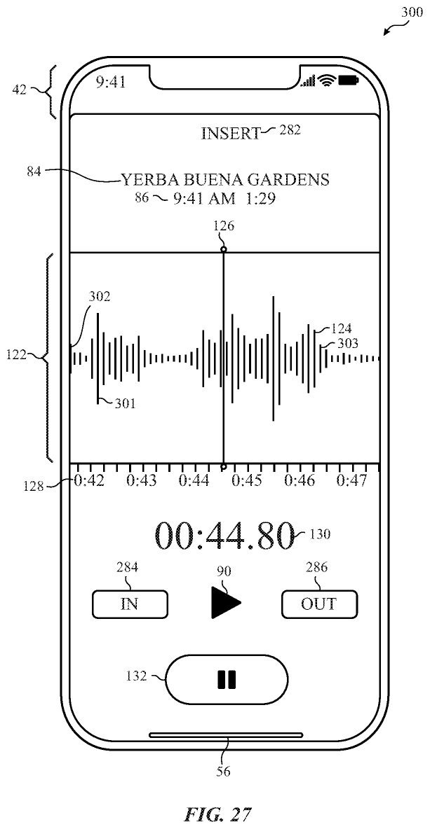

FIG. 27 illustrates an insert record screen 300 that results from a selection of the dynamic button 132 in the insert screen 290 of FIG. 26. The insert record screen 300 indicates a recording is currently occurring by morphing the dynamic button 132 into a pause button. Additionally, the insert record screen 300 includes an insertion section 301 that corresponds to audio that has been recorded since the dynamic button 132 was pressed in the insert screen 290. The insertion section 301 may be marked with a first color (e.g., red) and remaining sections 302 and 303 may be marked with a second color (e.g., grey). The remaining section 302 corresponds to audio that remains in its original location in the voice memorandum during the insertion, and the remaining section 303 corresponds to audio that is shifted later in time as the insertion section 301 grows larger as the recorded audio continues recording. Within the representation window 122, as the playhead 126 scrolls through the representation 124, the remaining section 302 visibly shifts left while the remaining section 303 remains in place.

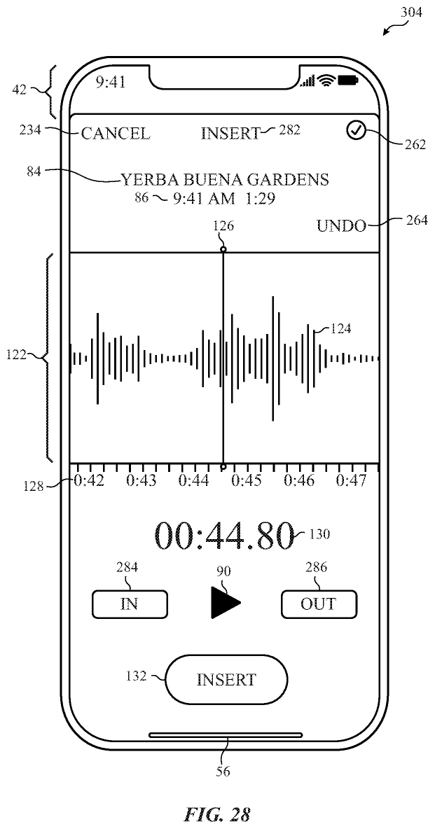

Once the dynamic button 132 is selected in the insert record screen 300 as indicating that recording is complete, the electronic device 10 displays a record complete screen, such as the record complete screen 304 of FIG. 28. After the recording is completed, the playhead 126 is located at the end of the representation 124 corresponding to the inserted audio. After recording is completed, the insertion may be saved using the confirmation button 262 or aborted using the cancel button 234. As previously noted, in some embodiments, selection of the confirmation button 262 or the cancel button 234 may cause the electronic device 10 to confirm whether the changes should be respectively saved or discarded.

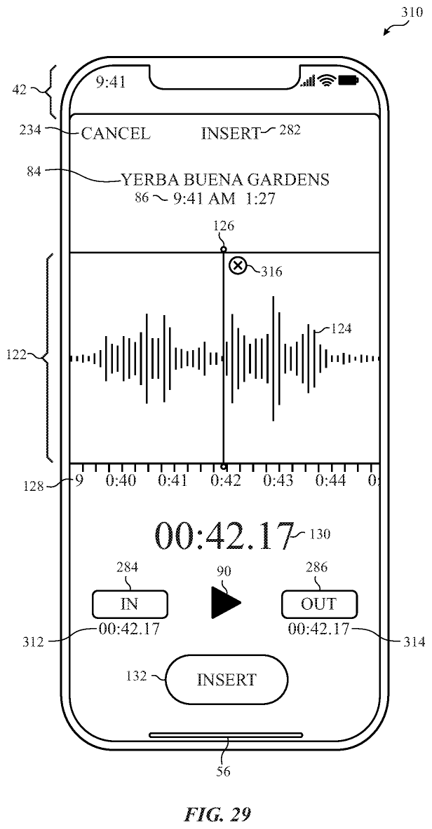

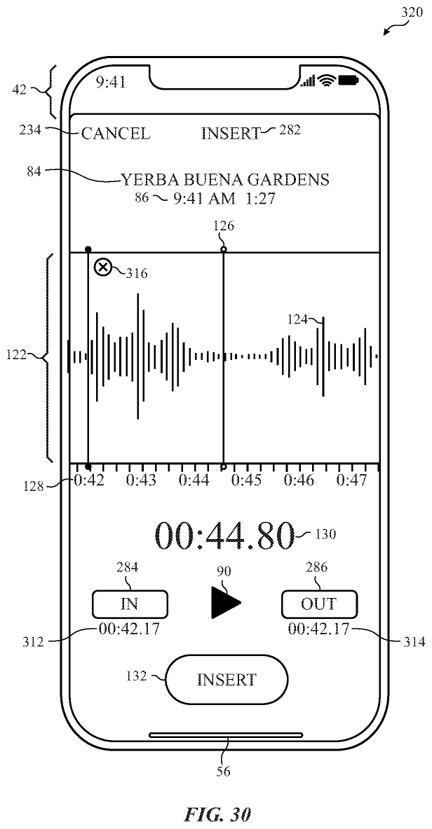

As previously noted, during the insert mode, when either the in button 284 or the out button 286 is pressed for a first time since a reset of the points, the both in and out points are set to the current location of the playhead 126, as indicated in an insert screen 310 illustrated in FIG. 29. The in point is indicated using an in point indicator 312, and the out point is indicated using an out point indicator 314. In the insert screen 310, these values are the same as only a single point is set. Any insert will be performed at the location even if inputs 14 cause traversal of the representation 124, such as illustrated in the screen 320 of FIG. 30. In other words, the insertion is performed at the location of the playhead 126 when the in button 284 or the out button 286 is pressed regardless of the current location of the playhead when the dynamic button 132 is pressed because the in button 284 and/or the out button 286 essentially locks the insert to the set location. Thus, since the in point indicator 312 is the same as the out point indicator 314 in the insert screen 310 and the screen 320, a press of the dynamic button 132 in either screen has the same result regardless of the scrolling difference between the appearance of the representation 124 between the screens. To undo the set location(s) set using the in button 284 and/or the out button 286, a cancel button 316 is presented to cancel the setting of the in and out points.

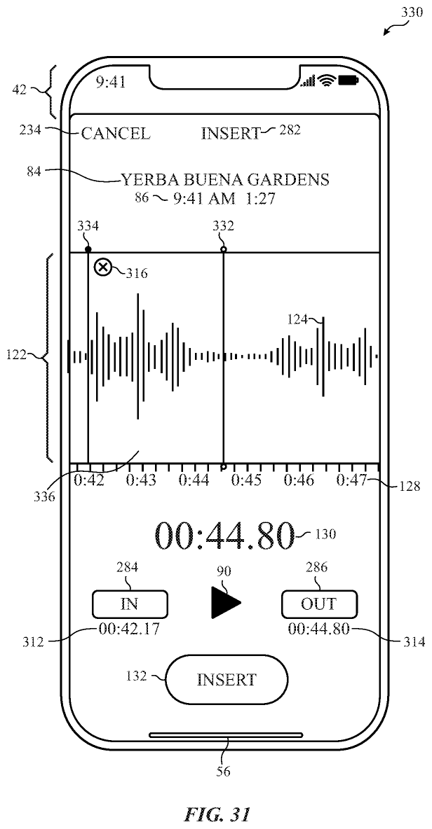

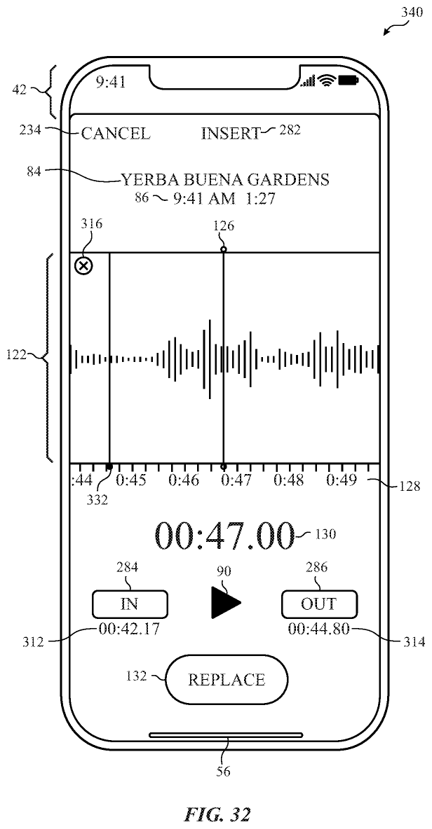

FIG. 31 illustrates an insert screen 330 that occurs after the out point is set using the out button 286 in the insert screen 320 as indicated by the out point indicator 314. Since the in and out points are not the same, indicators 332 and 334 represents ends of an insert region 336 that indicate on the representation 124 where newly recorded audio is to be placed when the dynamic button 132 is selected. Furthermore, since the newly recorded audio replaces at least some audio corresponding to the insert region 336, the dynamic button 132 includes replacement text to make clear that selection of the dynamic button 132 will replace some audio. Even if the recorded audio is longer or shorter than the audio corresponding to the insert region 336, only the audio corresponding to the insert region 336 is replaced. The remaining audio shifts to accommodate the difference in size between the newly recorded audio and the audio corresponding to the insert region 336. Thus, such actions may be a hybrid between insert and replace actions by partly replacing and partly inserting audio. The representation 124 may be traversed without changing the in and out points. For instance, the insert screen 340 of FIG. 32 corresponds to a traversal of the representation 124 without changing the in and out points. Selection of the dynamic button 132 in the insert screen 330 or the insert screen 340 results in deletion of audio corresponding to insert region 336 and recording audio to replace the deleted audio.

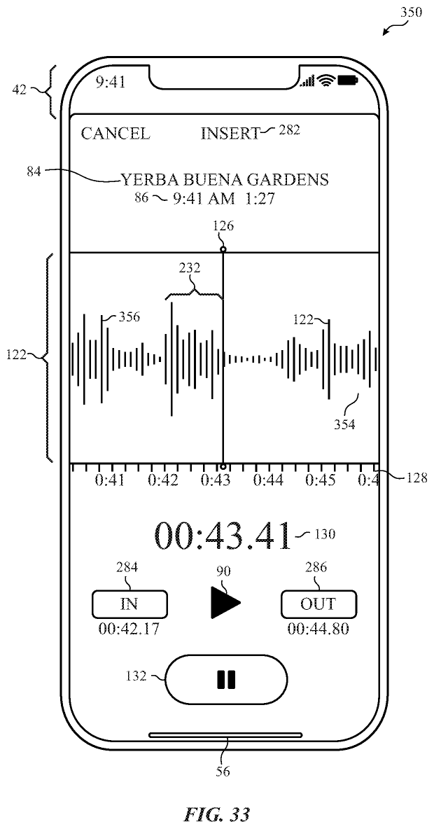

FIG. 33 illustrates a recording progress screen 350 where the insert region 336 has been deleted, and a new region 352 corresponding to audio being currently recorded has replaced the insert region 336. To make the new region 352 more visible, the new region may have a different color (e.g., red) than a color (e.g., grey) of the remaining portion of the representation 124. A right side 354 of the representation 124 remains in a constant position in the recording progress screen 350 during recording of audio corresponding to the new region 352 even though the audio corresponding to the right side 354 is shifted later in the voice memorandum as the audio corresponding to the new region 352 grows longer in the recording. A left side 356 of the representation 124 located to the left of the new region 352 scrolls left as the new region 352 becomes larger, but the position of audio corresponding to the left side 356 remains in a constant location in the audio of the voice memorandum. Since the recording progress screen 350 occurs during recording, the dynamic button 132 morphs into a pause button.

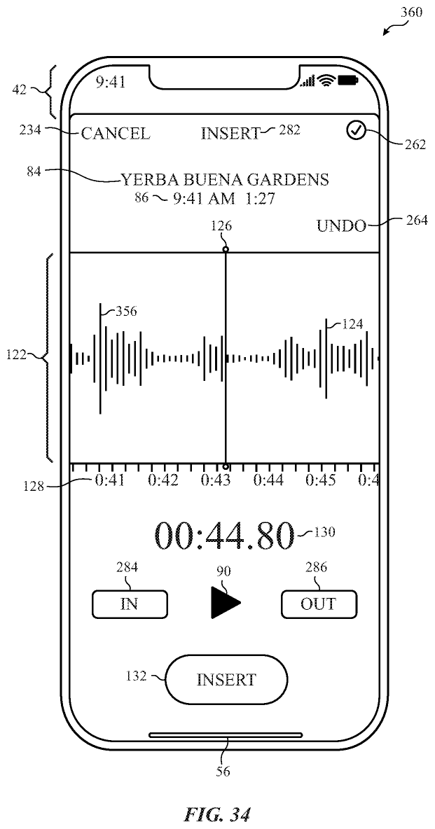

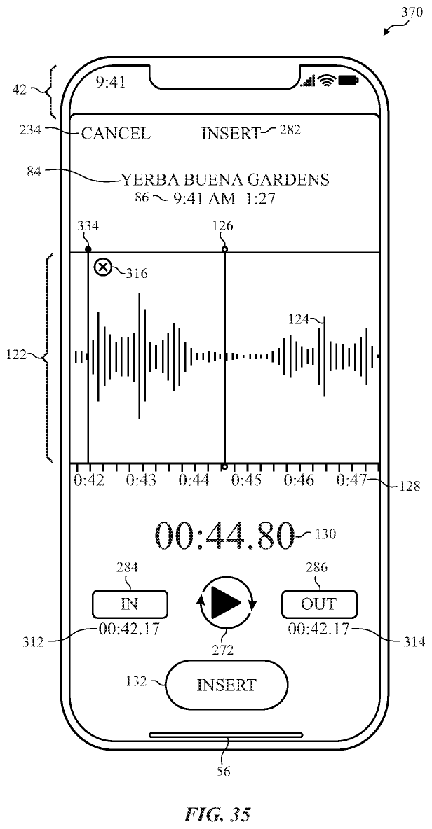

When the dynamic button 132 is pressed in the recording progress screen 350, the electronic device 10 may display a record complete screen 360 as illustrated in FIG. 34. In the record complete screen 360, the new region 352 may change colors (e.g., white) from a color (e.g., red) used in the recording progress screen 350 to indicate that recording has stopped. The confirmation button 262 may be used to save the insertion and may cause the electronic device 10 to request confirmation that the changes are to be saved to the original voice memorandum, saved to a new voice memorandum, or abort saving. The undo button 264 may be used to cancel the insertion and may cause the electronic device 10 to confirm whether the cancel should continue or be aborted.

Similar to the trim mode, the insert mode may use looping playback as depicted in the loop screen 370 of FIG. 35. In the insert mode, when an input (e.g., touch) is active on any of the in or out points, the play button 90 is replaced with the loop icon 272. Pressing the loop icon 272 continuously loops playback of a region (e.g., 1-second region, number of words) around the respective point to ensure that a proper position is selected. For instance, a looped portion may include audio occurring right after audio corresponding to the in point or audio occurring right before audio corresponding to the out point. Similar to the trim mode loop playback, loop playback may continue as long as the selection of the respective point or the loop icon 272 is selected to provide an efficient, easily manipulative interface to provide assurance that the point selected was the point intended.

### Library Editing

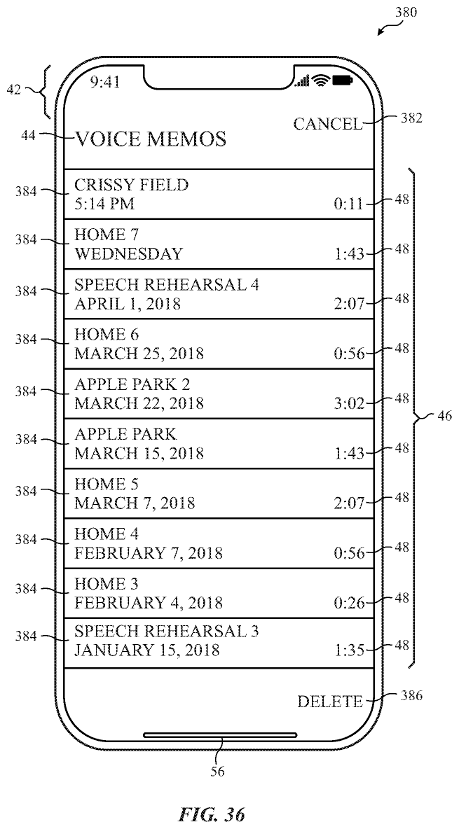

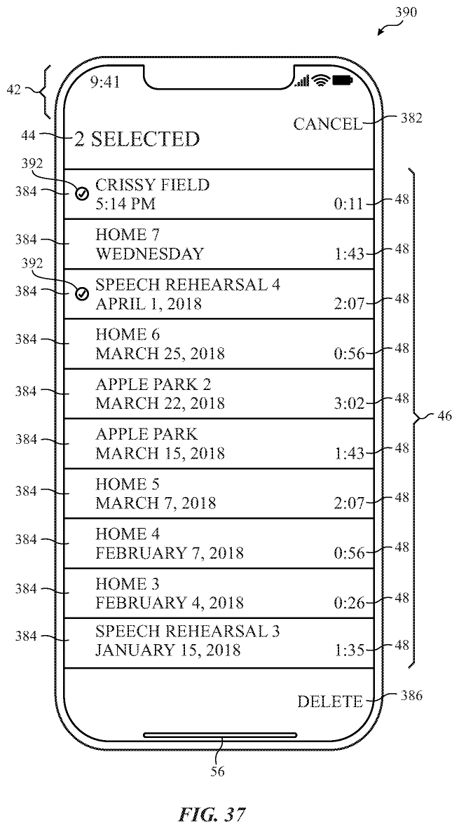

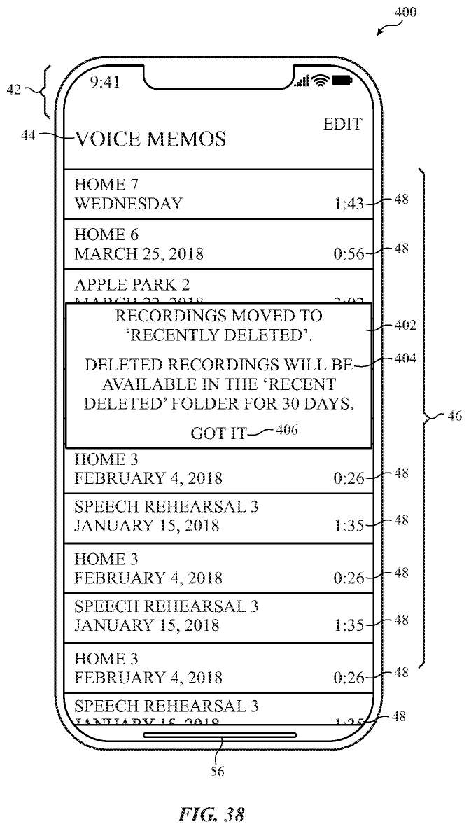

FIG. 36 illustrates an edit screen 380 that corresponds to a library edit mode that may result from a selection of the edit button 50 in the library screen 40. Upon selection of the edit button 50, the electronic device 10 displays the edit screen 380 that is similar to the library screen 40 except that the edit button 50 morphs into a cancel button to cancel the library edit mode and return to the library screen 40. The edit screen 380 also includes each indication 48 of voice memorandums having a respective selection bubble 384 that enables selection of the corresponding voice memorandums. When no voice memorandums are selected using corresponding selection bubbles 384, a delete button 386 may be disabled, dimmed, and/or omitted. Once one or more indications 48 are selected, as indicated in the edit screen 390 of FIG. 37, the delete button 386 becomes active. Once the delete button 386 is active and then selected, the electronic device 10 may present a confirmation screen, such as the confirmation screen 400 of FIG. 38. The confirmation screen includes a confirmation box 402. The confirmation box 402 includes confirmation text 404 that indicates information about the deletion. In this case, the confirmation text 404 indicates that the deleted voice memorandums have been moved to “Recently Deleted” folder and indicates how long the recording will be available. The confirmation box 402 also includes a confirmation button 406 that enables the electronic device 10 to confirm that the confirmation text 404 has been presented to a user.

### Other Device Interfaces

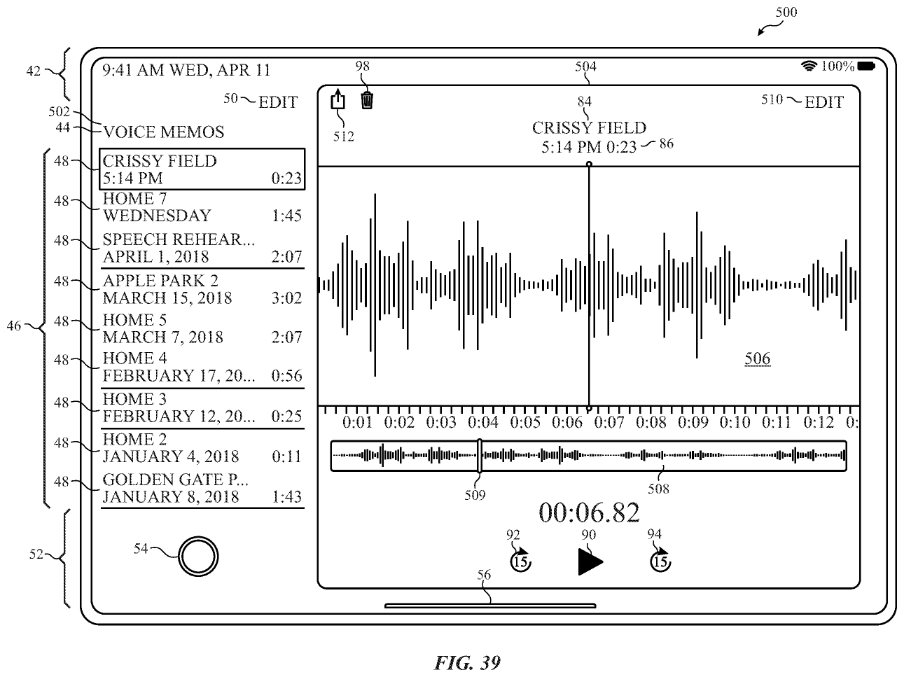

The foregoing figures illustrate the voice memorandum program interface on a mobile device (e.g., cellular phone). However, as previously noted, the voice memorandum program interface may be displayed on other devices, such as wearable devices, tablet computers, desktop computers, or laptop computers. Since the other devices have different sizes or ratios, the appearance of the voice memorandum program interface may be change depending upon which device is currently displaying the voice memorandum program interface. For instance, FIG. 39 illustrates a library screen 500 that may be displayed on a tablet, desktop, or laptop computer. The library screen 500 has all of the information in the library screen 80 of FIG. 8. Since tablet, desktop, or laptop computers have more space than a mobile device, the library screen 500 may include a sidebar 502 showing the library list 46 and the minimized card 52. In some embodiments, the sidebar 502 may be alternatively slid into the library screen 500 and/or slid out (and hidden) from the library screen 500. The library screen 500 uses the extra visual real estate to include a details card 504. The details card 504 includes a first representation 506 of the audio recording and a second representation 508 of the audio recording. The first representation 506 is a zoomed view of a portion of the second representation 508 since the second representation 508 is a representation of the entire audio recording. The details card 504 also may include an indicator 509 that may be used to indicate a location where corresponding audio will begin playing upon selection of the play button 90. In some embodiments, the indicator 509 may be slid through the second representation 508 to change which audio plays upon selection of the play button 90.

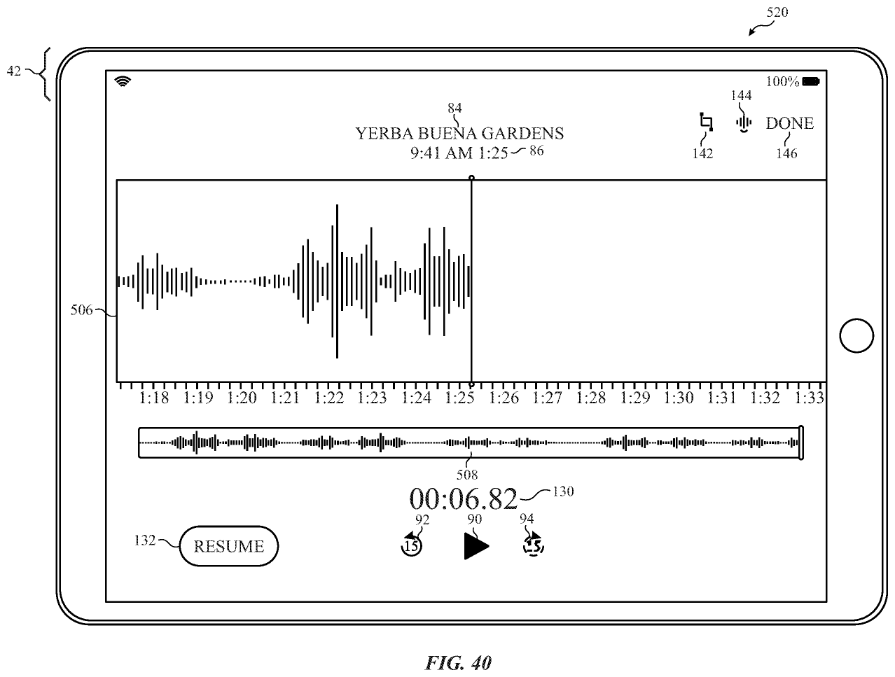

The details card 504 also includes an edit button 510 and a share button 512 that correspond to the edit recording button 102 and the share button 106 of FIG. 9. If the edit button 510 (or any part of the details card 504 other than the play button 90, the navigation buttons 92 and 94, the title 84, the delete button 98, or the share button 512) is selected, a detailed view 520, as illustrated in FIG. 40, may be presented similarly to the resume screen 140 but with the first representation 506 and the second representation 508.

### Flow Diagrams

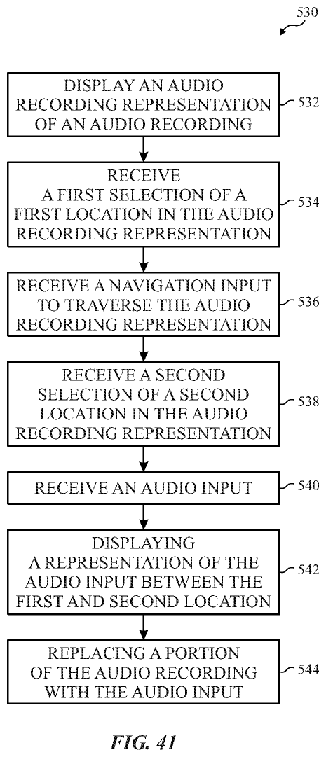

FIG. 41 illustrates a process 530 that may be deployed by the electronic device 10 to replace audio in an audio recording. The electronic device 10 displays an audio recording representation of an audio recording in a voice memorandum application user interface (block 532). The electronic device 10 then receives, in the voice memorandum application user interface, a first selection of a first location in the audio recording representation (block 534). The first location corresponds to a first time of the audio recording. The electronic device 10 also receives, in the voice memorandum application user interface, a navigation input to traverse the displayed audio recording representation to a second location in the audio recording representation (block 536). The electronic device 10 then receives, in the voice memorandum application user interface, a second selection of the second location in the displayed audio recording representation (block 538). The second location corresponds to a second time of the audio recording. The electronic device 10 also receives, in the voice memorandum application user interface, an audio input (block 540). For example, a selection may be received via the dynamic button 132 causing a microphone of the electronic device 10 to begin recording audio. While receiving the audio input, the electronic device 10 displays a representation of the audio input between the first and second locations of the displayed audio recording representation (block 542). Once recording has been completed, the electronic device 10 replaces a portion of the audio recording corresponding to a portion of the displayed audio recording representation located between the first and second locations (block 544). Replacing the portion includes shifting subsequent portions of the audio recording forward or backward in the audio recording based at least in part on a length of the portion and a length of the audio input.

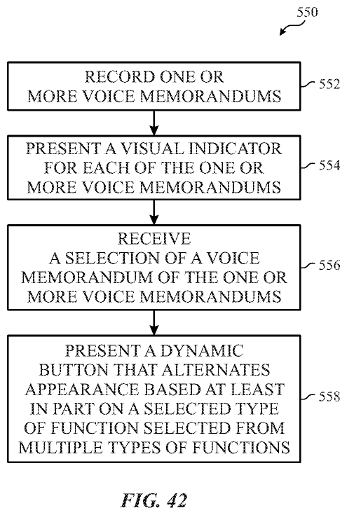

FIG. 42 illustrates a process 550 that may be deployed by the electronic device 10 using the voice memorandum program user interface. The electronic device 10 records one or more voice memorandums (block 552). The electronic device 10 then presents, in the voice memorandum application user interface, a visual indicator for each of the one or more voice memorandums (block 554). The electronic device 10 then receives, via the voice memorandum application user interface, a selection of a voice memorandum of the one or more voice memorandums (block 556). The electronic device 10, in response to the selection of the voice memorandum, presents, in the voice memorandum application user interface, a voice memorandum graphical user interface that includes the dynamic button 132 that alternates appearance based at least in part on a selected type of function selected from multiple types of functions to be performed on the voice memorandum (block 558).

The selected type of function is selected from the multiple types of functions based at least on one of: a location of a playhead 126 of the voice memorandum application user interface in the representation 124 corresponding to audio of the voice memorandum, an active mode activated for the voice memorandum application; or a number of reference points set on the representation 124 in the voice memorandum application user interface. For instance, the dynamic button 132 shows a pause button when the voice memorandum is currently being recorded. The dynamic button 132 may display a resume button when recording is paused and the playhead 126 is at an end of the representation 124. The dynamic button 132 may display a replace button when recording is paused and the playhead 126 is at any location other than an end of the representation 124. The dynamic button 132 may display an insert button when the playhead 126 is located at any point other than an end of the representation 124, the voice memorandum application user interface is in an insert mode, and recording is paused.

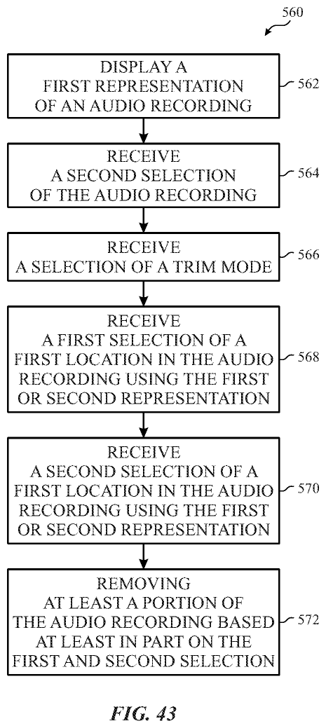

FIG. 43 illustrates a process 560 that may be employed by the electronic device 10. The electronic device 10 displays a first representation of an audio recording in a voice memorandum application user interface configured to represent the entire audio recording (block 562). The first representation includes the selection window 238 configured to select a portion of the audio recording. The electronic device 10 displays a second representation of the audio recording in the voice memorandum application user interface configured to represent a zoomed view of a portion of the audio recording (block 564). The electronic device 10 receives, in the voice memorandum application user interface, a selection of a trim mode for the voice memorandum application user interface (block 566). The electronic device 10 receives, in the voice memorandum application user interface, a first selection of a first location in the first representation using either the first or second representation of the audio recording (block 568). The first location corresponds to a first time of the audio recording. The electronic device 10 receives, in the voice memorandum application user interface, a second selection of a second location in the first representation (block 570). The second location corresponds to a second time of the audio recording. The electronic device 10 removes at least a portion of the audio recording based at least in part on the first and second selection (block 572). The removal corresponds to a deletion or a trim of the audio recording.

The processes previously discussed may be utilize hardware implementations, software implementations, and/or a combination thereof. For instance, in some embodiments, the processor core complex 18 may execute instructions stored in the memory 20 that cause the processor core complex 18 to perform the steps previously described.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
displaying an audio recording representation of an audio recording in a voice memorandum application user interface;
receiving, in the voice memorandum application user interface, a first selection of a first location in the audio recording representation, the first location corresponding to a first time of the audio recording;
receiving, in the voice memorandum application user interface, a navigation input to traverse the displayed audio recording representation to a second location in the audio recording representation;
receiving, in the voice memorandum application user interface, a second selection of the second location in the displayed audio recording representation, the second location corresponding to a second time of the audio recording;
receiving, in the voice memorandum application user interface, an audio input;
while receiving the audio input, displaying a representation of the audio input between the first and second locations of the displayed audio recording representation; and
replacing, using the voice memorandum application user interface, a portion of the audio recording corresponding to a portion of the displayed audio recording representation located between the first and second locations, wherein replacing the portion comprises shifting subsequent portions of the audio recording forward or backward in the audio recording based at least in part on a length of the portion and a length of the audio input.

2. The method of claim 1, comprising replacing a play button of the voice memorandum application user interface with a loop icon during receipt of the first or second selection while a respective input corresponding to receiving the first or second selections is active.

3. The method of claim 2, comprising:
receiving a selection of the loop icon while the respective input is used to receive the first selection; and
in response to the selection of the loop icon, looping audio at a point in the audio recording corresponding to the first location.

4. The method of claim 3, wherein the first location is located earlier in the audio recording representation than the second location, and the looped audio corresponds to a portion of the audio recording occurring for a duration after the point in the audio recording.

5. The method of claim 3, wherein the first location is located later in the audio recording representation than the second location, and the looped audio corresponds to a portion of the audio recording occurring for a duration before the point in the audio recording.

6. The method of claim 3, wherein the looping of audio repeats as long at least one of the loop icon or the respective input corresponding to receiving the first or second selections is active.

7. The method of claim 1, wherein traversing the audio recording representation comprises scrolling in response to a swipe motion, and the scrolling through the audio recording representation at a speed at least partially set according to a distance or speed of the swipe motion.

8. The method of claim 1, wherein traversing the audio recording representation comprises scrolling from word-to-word in the audio recording.

9. The method of claim 8, wherein scrolling from word-to-word in the audio recording is based at least in part spaces of lower amplitude greater than a word-space threshold in the audio recording.

10. The method of claim 8, wherein scrolling from word-to-word comprises scrolling from sharp consonant sound to sharp consonant sound in the audio recording.

11. Non-transitory, tangible, and computer-readable medium storing instructions that, when executed by a processor, are configured to cause the processor to:
record one or more voice memorandums;
present, in a voice memorandum application user interface, a visual indicator for each of the one or more voice memorandums;
receive, via the voice memorandum application user interface, a selection of a voice memorandum of the one or more voice memorandums; and
in response to the selection of the voice memorandum, present, in the voice memorandum application user interface, a voice memorandum graphical user interface that includes a dynamic button that alternates appearance based at least in part on a selected type of function selected from a plurality of types of functions to be performed on the voice memorandum, wherein the selected type of function is selected from the plurality of types of functions based at least one of:
a location of a playhead of the voice memorandum application user interface in an audio recording representation corresponding to audio of the voice memorandum;
an active mode activated for the voice memorandum application user interface; and
a number of reference points set on the audio recording representation in the voice memorandum application user interface.

12. The non-transitory, tangible, and computer-readable medium of claim 11, wherein the dynamic button is configured to show a pause button when a voice memorandum is currently being recorded using the voice memorandum application user interface.

13. The non-transitory, tangible, and computer-readable medium of claim 11, wherein the dynamic button is configured to show a resume button when:
the playhead is located at an end of the audio recording representation; and
recording of a voice memorandum is currently paused.

14. The non-transitory, tangible, and computer-readable medium of claim 11, wherein the dynamic button is configured to show a replace button when:
the playhead is located at any point other than an end of the audio recording representation; and
recording of a voice memorandum is currently paused.

15. The non-transitory, tangible, and computer-readable medium of claim 11, wherein the dynamic button is configured to show an insert button when:
the playhead is located at any point other than an end of the audio recording representation;
the voice memorandum application user interface is in an insert mode; and
recording of a voice memorandum is currently paused.

16. The non-transitory, tangible, and computer-readable medium of claim 15, comprising:
receiving a selection of an insert button in the voice memorandum graphical user interface; and
in response to receiving the selection of the insert button, setting the voice memorandum application user interface in the insert mode.

17. A system comprising:
memory storing instructions; and
a processor configured to execute the instructions to cause the processor to:
displaying a first representation of an audio recording in a voice memorandum application user interface configured to represent the entire audio recording, wherein the first representation comprises a selection window configured to select a portion of the audio recording;
displaying a second representation of the audio recording in the voice memorandum application user interface configured to represent a zoomed view of a portion of the audio recording;
receiving, in the voice memorandum application user interface, a selection of a trim mode for the voice memorandum application user interface;
receiving, in the voice memorandum application user interface, a first selection of a first location in the first representation using the first or second representation of the audio recording, the first location corresponding to a first time of the audio recording;
receiving, in the voice memorandum application user interface, a second selection of a second location in the displayed first representation, the second location corresponding to a second time of the audio recording; and
removing at least a portion of the audio recording based at least in part on the first and second selection.

18. The system of claim 17, wherein a default size of the selection window comprises an entire length of the first representation.

19. The system of claim 18, wherein the selection window comprises handles configure to enable selection of the first and second locations for the selection window, and wherein the selection window is configured to change color when at least one of the first or second selection is received.

20. The system of claim 18, wherein in response to the selection of the first or second locations, the processor is configured to activate:
a trim button that is configured to delete a first portion of the audio recording corresponding to portions of the first representation outside of the selection window; and
a delete button that is configured to delete a second portion of the audio recording corresponding to portions of the first representation inside the selection window.
